(19) United States
(12) Patent Application Publication
(10) Pub. No.: US 2023/0350318 A1
(43) Pub. Date: Nov. 2, 2023

(54) IMAGE FORMING SYSTEM AND METHOD FOR FORMING IMAGE

(71) Applicant: Konica Minolta, Inc., Tokyo (JP)

(72) Inventors: Keiji ARAI, Tokyo (JP); Kentarou MOGI, Tokyo (JP); Atsushi IIOKA, Kawasaki-shi (JP); Minori MOMMA, Tokyo (JP)

(21) Appl. No.: 18/299,138

(22) Filed: Apr. 12, 2023

(30) Foreign Application Priority Data
Apr. 27, 2022 (JP) 2022-073145

(51) Int. Cl. G03G 9/087; G03G 9/097; G03G 5/02; G03G 9/08

(52) U.S. Cl. CPC G03G 9/0825; G03G 5/0217; G03G 9/0827; G03G 9/08755; G03G 9/0975

(57) ABSTRACT

An image forming system uses: an organic photoreceptor; and a toner for electrostatic charge image development containing toner particles, wherein the organic photoreceptor has a protective layer containing a cured resin; the toner particle has a form in which at least one type of lubricant particle and at least one type of non-lubricant particle are contained or adhered on a surface of a plurality of convex portions or on a surface between the plurality of convex portions, of a toner base particle having the plurality of convex portions thereon; and an average spacing D1 of the convex portions on the surface of the toner base particle, a median diameter D2 of the lubricant particle having the smallest median diameter, and a median diameter D3 of the non-lubricant particle having the largest median diameter, satisfy the relationship of the following formula (1): Formula (1) D3≤D1≤D2.

### CROSS REFERENCE TO RELATED APPLICATIONS

The entire disclosure of Japanese Patent Application No. 2022-073145 filed on Apr. 27, 2023 is incorporated herein by reference in its entirety.

### TECHNICAL FIELD

The present invention relates to an image forming system and a method for forming an image.

More specifically, the present invention relates to an image forming system and the like, which achieve both inhibition of wear and tear of an organic photoreceptor and lowering of deposits on the organic photoreceptor.

### DESCRIPTION OF THE RELATED ART

In order to prolong lives of organic photoreceptors used in electrophotographic image formation, applications of cured resins on photoreceptor surface layers have been studied (see, for example, JP2015-84078A and JP2019-95700A). Curable photoreceptors in which a protective layer on the surface thereof contains a cured resin, inhibit wear and tear and improve durability. However, inhibition of wear and tear makes it difficult to refresh a photoreceptor surface, thereby newly resulting in a problem of facilitating adhesion of foreign matters derived from toner to the photoreceptor surface. Deposits adhering and growing on the photoreceptor surface are then transferred to a recording media and arise a poor charge of the photoreceptor, which thereby can cause lowering of image quality.

One method for solving the problem of deposits on a photoreceptor is a method involving supplying sufficient lubricant particles on the photoreceptor to lower adhesiveness between foreign matters and the photoreceptor. Means for supplying lubricant on the photoreceptor include means with a lubricant supplying apparatus; however, means for externally adding lubricant to a surface of toner base particles is frequently adopted, from the viewpoint of simplification and miniaturization of apparatus configuration. The lubricant particles externally added to the surface of the toner base particles are released from the toner base particles on the photoreceptor and are supplied to the photoreceptor.

However, deposits have not been sufficiently lowered only by supplying lubricant using conventional lubricant-containing toner, in image forming using a curable photoreceptor, thereby requiring a new technology that can achieve both inhibition of wear and tear of an organic photoreceptor and lowering of deposits on the organic photoreceptor.

### SUMMARY OF THE INVENTION

The present invention has been made in view of the aforementioned problems and circumstances, and an object to solve the problems is to provide an image forming system that can achieve both inhibition of wear and tear of an organic photoreceptor and lowering of deposits on the organic photoreceptor, and a method for forming an image.

The present inventors have found, as a result of having investigated the cause of the aforementioned problems and the like in order to solve them, that use of an organic photoreceptor having a protective layer containing a cured resin and toner in which the relationship is specified, between an average spacing of convex portions on a surface of a toner base particle, a median diameter of a lubricant particle, and a median diameter of a non-lubricant particle, makes it possible to achieve both inhibition of wear and tear of the organic photoreceptor and lowering of deposits on the organic photoreceptor, and thus have completed the present invention.

That is, the foregoing object of the present invention will be achieved by the following measures.

To achieve at least one of the abovementioned objects, according to an aspect of the present invention, an image forming system reflecting one aspect of the present invention uses: an organic photoreceptor; and a toner for electrostatic charge image development comprising toner particles,
wherein the organic photoreceptor has a protective layer comprising a cured resin;
the toner particle has a form in which at least one type of lubricant particle and at least one type of non-lubricant particle are contained or adhered on a surface of a plurality of convex portions or on a surface between the plurality of convex portions, of a toner base particle having the plurality of convex portions on a surface thereof; and
an average spacing D1 of the convex portions on the surface of the toner base particle, a median diameter D2 of the lubricant particle having the smallest median diameter, and a median diameter D3 of the non-lubricant particle having the largest median diameter, satisfy the relationship of the following formula (1):
Formula (1) D3≤D1≤D2, is provided.

According to an aspect of the present invention, a method for forming an image reflecting one aspect of the present invention uses an organic photoreceptor and a toner for electrostatic charge image development comprising toner particles,
wherein the organic photoreceptor has a protective layer comprising a cured resin;
the toner particle has a form in which at least one type of lubricant particle and at least one type of non-lubricant particle are contained or adhered on a surface of a plurality of convex portions or on a surface between the plurality of convex portions, of a toner base particle having the plurality of convex portions on a surface thereof; and
an average spacing D1 of the convex portions on the surface of the toner base particle, a median diameter D2 of the lubricant particle having the smallest median diameter, and a median diameter D3 of the non-lubricant particle having the largest median diameter, satisfy the relationship of the following formula (1),
Formula (1) D3≤D1≤D2, is provided.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1: A SEM image of a toner base particle having a plurality of convex portions on a surface thereof;

FIG. 2: An explanatory view illustrating an average spacing of convex portions on the surface of a toner base particle precursor;

FIG. 3: An explanatory cross-sectional view illustrating an example of a configuration of an image forming apparatus;

FIG. 4: An explanatory cross-sectional view illustrating an example of a configuration of the key part of an image forming apparatus; and

FIG. 5: A schematic view illustrating an example of a configuration of a charger.

### DETAILED DESCRIPTION

Hereinafter, one or more embodiments of the present invention will be described with reference to the drawings. However, the scope of the invention is not limited to the disclosed embodiments.

The image forming system of the present invention is an image forming system using: an organic photoreceptor; and a toner for electrostatic charge image development comprising toner particles, characterized in that the organic photoreceptor has a protective layer comprising a cured resin; the toner particle has a form in which at least one type of lubricant particle and at least one type of non-lubricant particle are contained or adhered on a surface of a plurality of convex portions or on a surface between the plurality of convex portions, of a toner base particle having the plurality of convex portions on a surface thereof; and an average spacing D1 of the convex portions on the surface of the toner base particle, a median diameter D2 of the lubricant particle having the smallest median diameter, and a median diameter D3 of the non-lubricant particle having the largest median diameter, satisfy the relationship of the following formula (1):

$$\text{D3} \leq \text{D1} \leq \text{D2} \text{.} \qquad \text{Formula (1)}$$

The characteristics are technical characteristics common to or corresponding to the following embodiments.

In an embodiment of the image forming system of the present invention, the convex portion preferably contains a hybrid amorphous polyester resin in which a vinyl-based polymerization segment and an amorphous polyester-based polymerization segment are bonded via a bireactive monomer. The coexistence of the polyester-based polymerization segment and a vinyl-based polymerization segment with lower chargeability than the polyester-based polymerization segment in the convex portion inhibits overcharge of toner particles and lowers electrostatic adhesion between the toner particles and an organic photoreceptor, thereby enabling further lowering of adhesion of foreign matters derived from the toner on the organic photoreceptor. Moreover, the presence of the vinyl-based polymerization segment in the convex portion lowers electrostatic adhesion between the toner base particle and lubricant particle, thereby facilitating supplying of lubricant particles onto the organic photoreceptor.

In an embodiment of the image forming system of the present invention, the lubricant particle is preferably a fatty acid metal salt particle. Using the fatty acid metal salt particle that is positively charged as a lubricant particle, inhibits overcharge of toner and lowers electrostatic adhesion between the toner particles and the photoreceptor, thereby enabling further lowering of adhesion of foreign matters derived from the toner on the photoreceptor.

In an embodiment of the image forming system of the present invention, at least one type of non-lubricant particle described above is preferably a particle with a Mohs hardness of 8 or more. Adhesion of the non-lubricant particle, which is a nucleus material of a deposit on the photoreceptor, to the toner base particle is increased and the amount released is lowered, thereby enabling lowering of the amount of deposits on the photoreceptor even more.

In an embodiment of the image forming system of the present invention, the protective layer preferably contains metal oxide particles. This inhibits the wear and tear and further improves durability.

An embodiment of the image forming system of the present invention preferably comprises a charger of a roller charging type. The charger of the roller charging type makes it possible to greatly lower the amount of ozone generated, and also to achieve an inhibition effect of power consumption and save space by being capable of reducing an applied voltage, compared to a corona charging type.

In an embodiment of the image forming system of the present invention, a release ratio R of the fatty acid metal salt particle from the toner base particle in the toner particle, as determined by an ultrasonic treatment method under the above conditions, is preferably within a range of 20 to 60%. Release ratio R being 20% or more enables a moderate amount of lubricant particles that can reduce toner adhesion to be supplied on a photoreceptor. The release ratio being 60% or less also inhibits extreme release of lubricant particles, and inhibits excessive supply of lubricant particles onto the photoreceptor, thereby enabling inhibition of poor images such as lubricant memory.

The method for forming an image of the present invention is a method using an organic photoreceptor and a toner for electrostatic charge image development comprising toner particles, characterized in that the organic photoreceptor has a protective layer comprising a cured resin; the toner particle has a form in which at least one type of lubricant particle and at least one type of non-lubricant particle are contained or adhered on a surface of a plurality of convex portions or on a surface between the plurality of convex portions, of a toner base particle having the plurality of convex portions on a surface thereof; and an average spacing D1 of the convex portions on the surface of the toner base particle, a median diameter D2 of the lubricant particle having the smallest median diameter, and a median diameter D3 of the non-lubricant particle having the largest median diameter, satisfy the relationship of the following formula (1):

$$\text{D3} \leq \text{D1} \leq \text{D2} \text{.} \qquad \text{Formula (1)}$$

Hereinafter, the present invention and components thereof, and embodiments and aspects for carrying out the present invention will be described in detail. In the present application, “to” is used as the meaning including the lower limit and the upper limit of the numerical value described before and after the term.

### 1 Summary of Image Forming System

The image forming system of the present invention is an image forming system using an organic photoreceptor and a toner for electrostatic charge image development comprising toner particles (hereinafter simply referred to as “toner,” wherein the organic photoreceptor has a protective layer comprising a cured resin; the toner particle has a form in which at least one type of lubricant particle and at least one type of non-lubricant particle are contained or adhered on a surface of a plurality of convex portions or on a surface between the plurality of convex portions, of a toner base particle having the plurality of convex portions on a surface thereof, and an average spacing D1 of the convex portions on the surface of the toner base particle, a median diameter D2 of the lubricant particle having the smallest median diameter, and a median diameter D3 of the non-lubricant particle having the largest median diameter, satisfy the relationship of the following formula (1):

$$\text{D3} \leq \text{D1} \leq \text{D2} \text{.} \qquad \text{Formula (1)}$$

In the image forming system of the present invention, an apparatus section is specifically referred to as an “image forming apparatus” and the image forming system of the present invention forms an image by using the image forming apparatus and the toner according to the present invention.

Each configuration of the toner and the image forming apparatus will be described below.

### 2 Toner

The “toner” used herein refers to an aggregate of toner particles. In addition, the “toner particle” refers to a toner particle such that an external additive is added to a toner base particle. In the present invention, the toner particle may be simply referred to as a toner particle when there is no need to distinguish between the toner base particle and the toner particle.

The toner particle according to the present invention is characterized in that it has a form in which at least one type of lubricant particle and at least one type of non-lubricant particle are contained or adhered on a surface of a plurality of convex portions or on a surface between the plurality of convex portions, of a toner base particle having the plurality of convex portions on a surface thereof.

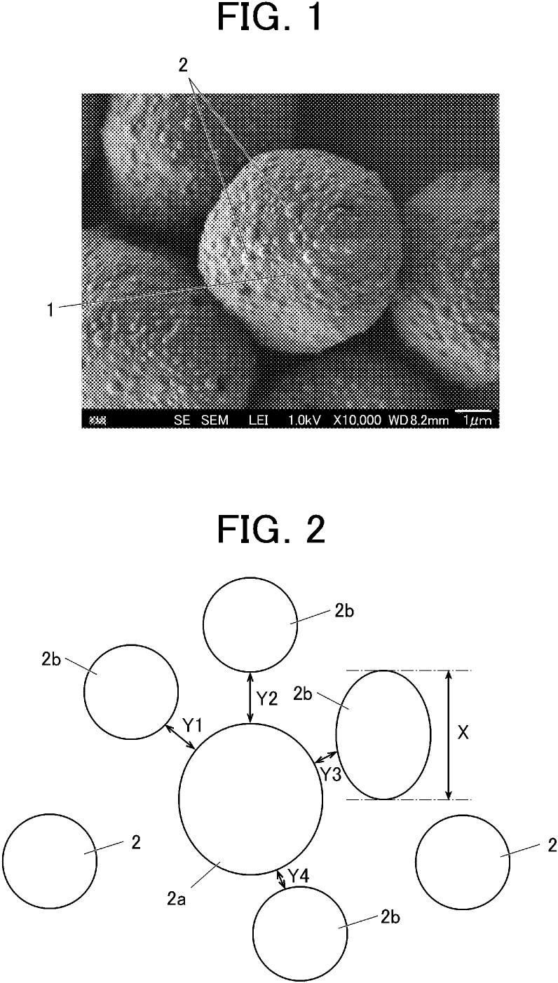

FIG. 1 is a scanning electron microscope (SEM) image of the toner base particles according to the present invention. The SEM image in FIG. 1 shows that the toner base particle is composed of a toner base particle precursor 1 and a plurality of convex portions 2 on the surface of the toner base particle.

The toner particle according to the present invention has a form in which an external additive such as a lubricant particle or a non-lubricant particle (not shown) is contained or adhered on surfaces of a plurality of convex portions or on a surface between the plurality of convex portions, of the toner base particle, as shown in the SEM image in FIG. 1.

In the present invention, the convex portion formed on the surface of a toner base particle is identified as follows. That is, a profile along a curved surface of a toner base particle surface is extracted for a toner particle included in an image photographed by SEM at a magnification of 10,000 times, and the profile is fitted to the curve concerned. The cross-sectional profile is corrected so that the curve becomes a straight line, and a plane by extending the straight line obtained in the direction perpendicular to the photographed image plane is taken as a reference plane. A long side length of a convex portion is defined as the longest distance thereof obtained when a contour of a location corresponding to the location separated with respect to the obtained reference plane by 30 nm or larger in the direction opposite to the center of a toner base particle, is sandwiched by two parallel lines, and the convex portion is defined as a portion with the long side length of 30 nm to 2,000 nm.

Hereinafter, the relationship between an average spacing of convex portions on the surface of a toner base particle, a median diameter of a lubricant particle, a median diameter of a non-lubricant particle (D3≤D1≤D2), which is specified as an essential requirement for solving the problems of the present invention, and a preferred embodiment of toner, will be described.

### <2.1 D3≤d1≤d2>

The toner particle of the present invention is characterized in that the relationship of the following formula (1) is satisfied. This allows the toner that is an aggregate of the toner particles to be a toner in which lubricant particles are easily released from the toner base particles and non-lubricant particles are unlikely to be released from the toner base particles.

$$\text{D3} \leq \text{D1} \leq \text{D2} \qquad \text{Formula (1)}$$

D1: Average spacing of convex portions on the surface of a toner base particle
D2: Median diameter of a lubricant particle with the smallest median diameter
D3: Median diameter of a non-lubricant particle with the largest median diameter

### (Average Spacing D1 of Convex Portions on the Surface of a Toner Base Particle)

Average spacing D1 of convex portions is a value obtained using SEM image data. The method for obtaining average spacing D1 of convex portions will be explained using FIG. 2.

First, in SEM image data of toner base particles observed at a magnification of 10,000 times, one convex portion with a long side length of 30 nm or longer is randomly picked up. Here, the convex portion picked up is illustrated as a convex portion 2a in FIG. 2. Next, four convex portions are picked up in order of proximity from the convex portion 2a, with the convex portion 2a as the center. Here, the four convex portions picked up are illustrated as convex portions 2b in FIG. 2. Each long side length X of four convex portions 2b picked up does not matter. The shortest distance (each from Y1 to Y4) from the circumference of the center convex portion 2a to the circumference of each of the four convex portions 2b picked up, is measured. Then, an average shortest distance Yave, which is the average value from Y1 to Y4, is determined.

First, different convex portions are randomly picked up in the same toner base particle, and average shortest distance Yave values are measured for a total of 20 convex portions as center convex portions. Furthermore, different toner base particles are picked up, and average shortest distance Yave values of a total of 20 convex portions as center convex portions, are measured in the same manner for a total of 5 toner base particles, respectively. Average shortest distances Yave values in total of 100 particles are averaged to obtain average spacing D1 of convex portions.

D1 is preferably within a range of 20 to 200 nm. D1 being 20 nm or larger facilitates penetration of non-lubricant particles between convex portions. D1 being 200 nm or smaller allows non-lubricant particles to be densely present to enhance their adhesion to toner base particles, further enabling control of the amount released.

### (Median Diameter D2 of Lubricant Particle With the Smallest Median Diameter)

The “lubricant particle with the smallest median diameter” of D2 refers to a type of lubricant particle in a case in which only one type of lubricant particle is present, and refers to a type of lubricant particle with the smallest median diameter in the case of the presence of plural types of lubricant particles.

D2 is preferably within a range of 500 to 3,000 nm. D2 being 500 nm or larger makes it more difficult for a lubricant particle to adhere between convex portions. D2 being 3,000 nm or smaller inhibits extreme release, and inhibits excessive supply of lubricant particles onto a photoreceptor, thereby enabling inhibition of poor images such as lubricant memory.

### (Median Diameter D3 of Non-Lubricant Particle With the Largest Median Diameter)

The “non-lubricant particle with the largest median diameter” of D3 refers to a type of non-lubricant particle in a case in which only one type of non-lubricant particle is present, and refers to a type of non-lubricant particle with the largest median diameter in the case of the presence of plural types of non-lubricant particles.

D3 is preferably within a range of 50 to 200 nm. D3 being 50 nm or larger inhibits non-lubricant particles from being aggregated with each other and facilitates adhesion thereof as primary particles to the surface of toner base particles, thereby facilitating penetration between convex portions. In addition, D3 being 200 nm or smaller strengthens adhesion of non-lubricant particles to the surface of toner base particles, further enabling control of the amount released.

### (Measurement Method of Median Diameters of Lubricant Particle and Non-Lubricant Particle)

The median diameters of the lubricant particle and non-lubricant particle in the present invention are measured in accordance with JIS Z 8825-1 (2001). Specifically, they are measured as follows.

A laser diffraction and scattering particle size analyzer “LA-920” (manufactured by HORIBA, Ltd.) is used as a measurement apparatus. A dedicated software “HORIBA LA-920 WET (LA-920) Ver. 2.02” attached to the LA-920 is used to set measurement conditions and analyzes measurement data. Ion-exchanged water from which impure solids and the like have been preliminarily removed is also used as a measurement solvent. The measurement procedure is as follows.

(1) A batch-type cell holder is attached to the LA-920.

The batch-type cell is charged with a predetermined amount of ion-exchanged water and set in a batch cell holder.

An inside of the batch-type cell is stirred by using a dedicated stirrer tip.

A “Refractive Index” button on a “Display Condition Setting” screen is pushed and a file “110A000I” (relative refractive index 1.10) is selected.

On the “Display Condition Setting” screen, particle size basis is set to volume basis.

After warm-up operation for one hour or longer, an optical axis is adjusted followed by fine-tuned, and a blank is measured.

A glass 100-mL flat-bottomed beaker is charged with approximately 60 mL of ion-exchanged water. Thereto is added approximately 0.3 mL of a dilution of “Contaminon N” (a 10% by mass aqueous solution of a neutral detergent for cleaning precision measuring equipment with a pH of 7, composed of a nonionic surfactant, an anionic surfactant, and an organic builder, manufactured by Wako Pure Chemical Industries, Ltd.) diluted about 3 times by mass with ion-exchange water, as a dispersing agent.

An ultrasonic disperser “Ultrasonic Dispersion System Tetora 150” (manufactured by Nikkaki Bios Co., Ltd.) is prepared, which incorporates two oscillators with an oscillation frequency of 50 kHz, with their phases shifted 180 degrees and an electrical output of 120 W. A water vessel of the ultrasonic disperser is charged with approximately 3.3 L of ion-exchanged water, and added with approximately 2 mL of Contaminon N.

The beaker described in (7) above is set in a beaker fixing hole of the ultrasonic disperser, and the ultrasonic disperser is activated. Then, a height position of the beaker is adjusted so that a resonance state of a liquid surface of an aqueous solution in the beaker is maximized.

With the aqueous solution in the beaker in (9) above being irradiated with ultrasonic waves, approximately 1 mg of a specimen (particle to be measured) is added to the aqueous solution in the beaker in small quantities and is dispersed. Then, the ultrasonic dispersion treatment is continued for another 60 seconds. Upon this treatment, the specimen may float on a surface of liquid as a mass, in which case the beaker is shaken to submerge the mass in the water followed by ultrasonic dispersion for 60 seconds. In addition, a water temperature in the water vessel is preferably adjusted to 10 to 40° C. upon the ultrasonic dispersion.

An aqueous solution in which the specimen prepared in (10) above has been dispersed is immediately added to the batch-type cell in small quantities while paying attention not to allow air bubbles to enter the cell, and then a transmittance of a tungsten lamp is adjusted to 90 to 95%. A particle size distribution is then measured. A volume-based median diameter is calculated based on the volume-based particle size distribution data obtained.

### <2.2 Toner Base Particle>

The toner base particle according to the present invention is characterized in that it has a plurality of convex portions on a surface thereof.

Average spacing D1 of convex portions is characterized, as described above, in that it has median diameter D3 or larger of the non-lubricant particle with the largest median diameter and median diameter D2 or smaller of the lubricant particle with the smallest median diameter. Average spacing D1 of convex portions is also preferably within a range of 20 to 200 nm, as described above.

The toner base particle having a plurality of convex portions on a surface thereof is composed of a toner base particle precursor and a plurality of convex portions formed on the surface of the toner base particle precursor. The toner base particle precursor can be composed of a resin for toner base particle precursors, a coloring agent, a mold release agent, a charge control agent, and the like. The convex portion can be composed of a resin for convex portions.

### Resin for Toner Base Particle Precursors

The resin for toner base particle precursors preferably contains, for example, a vinyl resin and more preferably a vinyl resin and a crystalline resin.

The “crystalline resin” herein refers to a resin having a melting point, i.e., a clear endothermic peak upon temperature rise, in an endothermic curve obtained by differential scanning calorimetry (DSC: Differential scanning calorimetry). The “clear endothermic peak” refers to a peak with a half width of 15° C. or less in an endothermic curve when temperature is raised at a rate of temperature rise of 10° C./min. The “amorphous resin,” on the other hand, refers to a resin that exhibits no clear endothermic peak described above, although a baseline curve indicating that glass transition occurs, is observed in an endothermic curve obtained upon the same differential scanning calorimetry measurement described above.

### 1) Vinyl Resin

The vinyl resin according to the present invention is a resin obtained by polymerization using at least a vinyl-based monomer. Specific examples of amorphous vinyl resins include an acrylic resin, a styrene · acrylic copolymer resin. Of these, the amorphous vinyl resin is preferably a styrene · acrylic-based resin polymerized using a styrene-based monomer and an acrylic-based monomer. This allows an effect of more reliably inhibiting filming from occurring to be obtained.

Polymerizable monomers used for the aforementioned styrene · acrylic-based resin include, for example, an aromatic-based vinyl monomer and a (meth)acrylic acid ester-based monomer, with those having an ethylenically unsaturated bond that can undergo radical polymerization being preferred.

Examples of the aromatic-based vinyl monomers include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, 3,4-dichlorostyrene, and derivatives thereof. These aromatic-based vinyl monomers can be used singly or in combinations with two or more thereof.

Examples of (meth)acrylic acid ester-based monomers include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate, diethylaminoethyl methacrylate. These (meth)acrylic acid ester-based monomers can be used singly or two or more thereof can be combined for use.

Of the aforementioned monomers, the styrene-based monomer is preferably combined for use with the acrylic acid ester-based monomer or the methacrylic acid ester-based monomer.

As the aforementioned polymerizable monomers, a third vinyl-based monomer can also be used. Examples of the third vinyl-based monomers include acid monomers such as acrylic acid, methacrylic acid, maleic anhydride, and vinyl acetate, acrylamide, methacrylamide, acrylonitrile, ethylene, propylene, butylene vinyl chloride, N-vinylpyrrolidone, butadiene.

The aforementioned polymerizable monomer, which is a multifunctional vinyl-based monomer may be further used. Examples of multifunctional vinyl monomers include diacrylates such as ethylene glycol, propylene glycol, butylene glycol, and hexylene glycol, dimethacrylates and trimethacrylates of tertiary or higher alcohols such as divinylbenzene, pentaerythritol, and trimethylolpropane. A copolymerization ratio of the multifunctional vinyl-based monomer to the total polymerizable monomer is usually within a range of 0.001 to 5% by mass, preferably within a range of 0.003 to 2% by mass, and more preferably within a range of 0.01 to 1% by mass. Using the multifunctional vinyl-based monomer creates a gel component that is insoluble in tetrahydrofuran, and a proportion of the gel component in a total polymerization product is usually 40% by mass or less and preferably 20% by mass or less.

### 2) Crystalline Resin

The crystalline resin contained in the toner base particle precursors according to the present invention is preferably contained, for example, within a range of 3 to 20% by mass and particularly preferably within a range of 5 to 15% by mass, relative to the total mass of the resin contained in the toner base particles. The crystalline resin being 3% by mass or more renders favorable fixability and that being 20% by mass or less can prevent lowering of heat resistance due to an excessive increase in the amounts present on the surface of toner base particle precursors and on the surface of toner base particles, and can prevent transfer defects accompanying lowering of electrical resistance.

The crystalline resin for use, contained in the toner base particle precursors according to the present invention can be any publicly known crystalline resin.

From the viewpoint of obtaining excellent low-temperature fixability, the toner base particles preferably contain a crystalline polyester resin as the crystalline resin, and the content of the crystalline polyester resin in the toner base particles is preferably, for example, within a range of 3 to 20% by mass. The crystalline polyester resin being 3% by mass or more ensures sufficient low-temperature fixability, and that being 20% by mass or less firmly enables inhibition of toner scattering due to lowering of chargeability.

The crystalline polyester resin is a resin exhibiting crystallinity, among polyester resins obtained by polymerization reaction of a divalent or higher carboxylic acid (polyvalent carboxylic acid) monomer and a divalent or higher alcohol (polyhydric alcohol) monomer.

Examples of polyvalent carboxylic acid monomers that can be used in a synthesis of crystalline polyester resins include saturated aliphatic dicarboxylic acids such as oxalic acid, malonic acid, succinic acid, adipic acid, sebacic acid, azelaic acid, n-dodecyl succinic acid, 1,10-decane dicarboxylic acid (dodecanedioic acid), 1,12-dodecanedicarboxylic acid (tetradecanedioic acid); alicyclic dicarboxylic acids such as cyclohexanedicarboxylic acid; aromatic dicarboxylic acids such as phthalic acid, isophthalic acid, and terephthalic acid; polyvalent carboxylic acids with a valence of 3 or more, such as trimellitic acid and pyromellitic acid; anhydrides and alkyl esters having 1 to 3 carbon atoms, of these carboxylic acid compounds, and the like.

They may be used singly or in combinations with two or more thereof.

Examples of polyhydric alcohol monomers that can be used in the synthesis of crystalline polyester resins include aliphatic diols such as 1,2-propanediol, 1,3-propanediol, 1,4-butanediol, 1,5-pentanediol, 1,6-hexanediol, 1,7-heptanediol, 1,8-octanediol, 1,9-nonanediol, neopentyl glycol, and 1,4-butenediol; polyhydric alcohols with a valence of 3 or more, such as glycerin, pentaerythritol, trimethylolpropane, and sorbitol.

They may be used singly or two or more thereof may be combined for use.

### 3) Glass Transition Point and Softening Point of Resin for Toner Base Particle Precursors

A glass transition point Tg of a resin for toner base particle precursors is preferably, for example, within a range of 40 to 60° C. A softening point Tsp of the resin for toner base particle precursors is also preferably, for example, within a range of 80 to 130° C.

Glass transition point Tg of the resin for toner base particle precursors herein can be measured by the method (DSC method) specified in ASTM (American Society for Testing and Materials) D3418-82.

Specifically, 3.0 mg of a sample is weighed to two decimal places, sealed in an aluminum pan, and set in a sample holder of a differential scanning calorimeter “Diamond DSC” (manufactured by Perkin Elmer, Inc.). An empty aluminum pan is used as a reference, and temperatures in temperature rise-temperature fall-temperature rise are controlled in a measurement temperature range of 0 to 200° C., at a rate of temperature rise of 10° C./min and a rate of temperature fall of 10° C./min, and data during the second temperature rise are used for analysis. A value of the intersection of an extended line of the baseline before a rise of the first endothermic peak and a tangent line exhibiting the maximum slope between the rise of the first endothermic peak and the peak apex is defined as glass transition point Tg.

Softening point Tsp of a resin for toner base particle precursors herein can be measured as follows.

First, 1.1 g of a resin is placed in a Petri dish, flattened and left undisturbed for 12 hours or longer, under an environment of 20±1° C. and 50±5% RH, and then pressurized by a molding machine “SSP-10A” (manufactured by Shimadzu Corporation) with a force of 3820 kg/cm² for 30 seconds to fabricate a cylindrical molded sample with a diameter of 1 cm. The sample is then placed into a flow tester “CFT-500D” (manufactured by Shimadzu Corporation) in an environment of 24±5° C. and 50±20% RH, and then extruded through a hole (1 mm diameter × 1 mm) in a cylindrical die using a piston with a diameter of 1 cm from upon completion of preheating, under the following conditions: load 196 N (20 kgf), starting temperature 60° C., preheating time 300 seconds, and rate of temperature rise 6° C./minute, and then an offset method temperature T_{offset} measured by a melting temperature measurement method in a temperature rise method at an offset value of 5 mm is defined as a softening point Tsp of the resin.

### 4) Production Method of Resin for Toner Base Particle Precursors

The resin for toner base particle precursors according to the present invention is preferably fabricated, for example, by emulsion polymerization method. The emulsion polymerization can be carried out by dispersing and polymerizing a polymerizable monomer such as styrene or acrylic acid ester in an aqueous medium. In order to disperse the polymerizable monomer in an aqueous medium, a dispersion stabilizer is preferably used, and a polymerization initiator, a chain transfer agent, or the like can be used for the polymerization.

### 4-1) Dispersion Stabilizer

In a case in which the polymerizable monomer is dispersed in an aqueous medium to prepare a resin for toner base particle precursors by the emulsion polymerization method, a dispersion stabilizer is usually added in order to prevent aggregation of dispersed droplets. Dispersion stabilizers that are publicly known surfactants can be used, and dispersion stabilizers selected from the cationic surfactants, anionic surfactants, nonionic surfactants, and the like, can be used. These surfactants may be used singly or two or more thereof may be combined for use. Note, however, the dispersion stabilizer can also be used in dispersions of coloring agents, anti-offsetting agents, and the like.

Specific examples of cationic surfactants include dodecylammonium bromide, dodecyltrimethylammonium bromide, dodecylpyridinium chloride, dodecylpyridinium bromide, and hexadecyltrimethylammonium bromide.

Specific examples of nonionic surfactants include dodecyl polyoxyethylene ether, hexadecyl polyoxyethylene ether, norylphenyl polyoxyethylene ether, lauryl polyoxyethylene ether, sorbitan monooleate polyoxyethylene ether, styrylphenyl polyoxyethylene ether, and monodecanoyl sucrose.

Specific examples of anionic surfactants include aliphatic soaps such as sodium stearate and sodium laurate, sodium lauryl sulfate, sodium dodecyl benzene sulfonate, and sodium polyoxyethylene (2) lauryl ether sulfate.

### 4-2) Polymerization Initiator

The polymerization initiator used for polymerization of the resin for toner base particle precursors is not particularly limited, and any publicly known initiator can be used. Specific examples thereof include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, tert-hydroperoxide pertriphenylacetate, tert-butyl perfomate, tert-butyl peracetate, tert-butyl perbenzoate, tert-butyl perphenylacetate, tert-butyl permethoxyacetate, and tert-butyl perN-(3-toluyl)palmitate; azo compounds such as 2,2′-azobis(2-aminodipropane)hydrochloride, 2,2′-azobis(2-aminodipropane)nitrate, 1,1′-azobis(1-methylbutyronitrile-3-sodium sulfonate), 4,4′-azobis-4-cyanovaleric acid, and poly(tetraethylene glycol-2,2′-azobisisobutyrate). The amount of polymerization initiator added varies depending on a desired molecular weight and molecular weight distribution, but specifically, it is preferably within a range of 0.1 to 5.0% by mass relative to the polymerizable monomers.

### 4-3) Chain Transfer Agent

In the production of the resin for toner base particle precursors according to the present invention, a chain transfer agent may be added together with the aforementioned polymerizable monomers. Addition of the chain transfer agent enables control of the molecular weight of a polymer. Upon polymerizing the aforementioned aromatic-based vinyl monomer and (meth)acrylic acid ester-based monomer, chain transfer agents commonly used can be used for the purpose of adjusting the molecular weight of a styrene · acrylic-based polymer segment. The chain transfer agent is not particularly limited, and examples thereof include alkyl mercaptans and mercapto fatty acid esters.

The amount of chain transfer agent added varies depending on a desired molecular weight and molecular weight distribution, but specifically, it is preferably within a range of 0.1 to 5.0% by mass relative to the polymerizable monomers.

### Mold Release Agent

Mold release agent that can be contained in the toner base particle precursors include wax.

Examples of the wax include hydrocarbon-based waxes such as low-molecular weight polyethylene wax, low-molecular weight polypropylene wax, Fischer-Tropsch wax, microcrystalline wax, and paraffin wax; and ester waxes such as carnauba wax, pentaerythritol behenate ester, behenyl behenate, and behenyl citrate.

They can be used singly or in combinations of two or more thereof.

Wax, the melting point of which is within a range of 50 to 95° C. is preferably used from the viewpoint of ensuring low-temperature fixability and mold releasability of toner.

A melting point of the mold release agent herein can be determined by carrying out differential scanning calorimetry (DSC: Differential scanning calorimetry) of toner. For example, a differential scanning calorimeter “Diamond DSC” (manufactured by Perkin Elmer, Inc.) can be used for the differential scanning calorimetry measurement. Toner undergoes measurement under the measurement conditions (temperature rise and cooling conditions) in which the first temperature rise process of raising the toner from 0° C. to 200° C. at a rate of temperature rise of 10° C./min and isothermally holding it at 200° C. for 5 minutes, a cooling process of cooling the toner from 200° C. to 0° C. at a cooling rate of 10° C./min and isothermally holding it at 0° C. for 5 minutes, and the second temperature rise process of raising the toner from 0° C. to 200° C. at a rate of temperature rise of 10° C./min, are performed in this order. The aforementioned measurement is carried out by sealing 3.0 mg of a mold release agent in an aluminum pan and setting it in a sample holder of a differential scanning calorimeter “Diamond DSC.” An empty aluminum pan is used as a reference. In the measurement described above, the endothermic curve obtained from the first temperature rise process is analyzed, and the top temperature of the endothermic peak derived from the mold release agent component is defined as a melting point [°C].

The content of wax is preferably within a range of 2 to 20% by mass, more preferably within a range of 3 to 18% by mass, and further preferably within a range of 4 to 15% by mass, relative to the total amount of resin for toner base particle precursors.

### Coloring Agent

For example, carbon black, magnetic materials, dyes, pigments, and the like can be optionally used as coloring agents that can be contained in the toner base particle precursors.

For example, channel black, furnace black, acetylene black, thermal black, lamp black, and the like can be used as carbon black.

For example, ferromagnetic metals such as iron, nickel, and cobalt, alloys containing these metals, compounds of ferromagnetic metals such as ferrite and magnetite, can be used as magnetic materials.

Examples of pigments include C. I. Pigment Red 2, 3, 5, 7, 15, 16, 48:1, 48:3, 53:1, 57:1, 81:4, 122, 123, 139, 144, 149, 166, 177, 178, 208, 209, and 222, C. I. Pigment Orange 31 and 43, C. I. Pigment Yellow 3, 9, 14, 17, 35, 36, 65, 74, 83, 93, 94, 98, 110, 111, 138, 139, 153, 155, 180, 181, and 185, C. I. Pigment Green 7, C. I. Pigment Blue 15:3, 15:4, and 60, and phthalocyanine pigments with central metals therein being zinc, titanium, magnesium, and the like, and mixtures thereof can also be used.

Examples of dyes include C. I. Solvent Red 1, 3, 14, 17, 18, 22, 23, 49, 51, 52, 58, 63, 87, 111, 122, 127, 128, 131, 145, 146, 149, 150, 151, 152, 153, 154, 155, 156, 157, 158, 176, and 179, pyrazolotriazole azo dyes, pyrazolotriazole azomethine dyes, pyrazolone azo dyes, pyrazolone azomethine dyes, C.I. Solvent Yellow 19, 44, 77, 79, 81, 82, 93, 98, 103, 104, 112, and 162, C. I. Solvent Blue 25, 36, 60, 70, 93, and 95, and the like, and mixtures thereof can also be used.

The content of coloring agent is preferably within a range of 1 to 30% by mass and more preferably within a range of 2 to 20% by mass, relative to the total amount of resin for toner base particle precursors.

### Charge Control Agent

Various publicly known charge control agents can be used as charge control agents that can be contained in toner base particle precursors.

The charge control agents that are, for example, various publicly known charge control agents dispersible in an aqueous medium can be used, and specific examples thereof include nigrosin-based dyes, metal salts of naphthenic acid or higher fatty acids, alkoxylated amines, quaternary ammonium salt compounds, azo-based metal complexes, salicylic acid metal salts or metal complexes thereof.

The content of charge control agent is preferably within a range of 0.1 to 10.0% by mass and more preferably within a range of 0.5 to 5.0% by mass, relative to the total amount of resin for toner base particle precursors.

### Other Additives

The toner base particle precursor can contain other additives as required. Other additives include magnetic powder, flowability improvers, conductivity adjusting agent, reinforcement fillers such as fibrous materials, antioxidants, cleanability improvers, and the like.

### Average Circularity of Toner Base Particle Precursor

An average circularity of the toner base particle precursor is preferably 0.890 or more.

The average circularity of the toner base particle precursors is an arithmetic mean value of circularity obtained by summing up circularity of each toner base particle precursor and dividing the obtained product by the total number of particles measured.

The circularity of the toner base particle precursor can be measured using a flow-type particle image analyzer “FPIA-2100” (manufactured by Sysmex Corporation). Specifically, toner base particle precursors are wetted in a surfactant aqueous solution, undergoing ultrasonic dispersion for 1 minute followed by dispersed, and then measured for circularity using the “FPIA-2100” in a measurement condition HPF (high magnification imaging) mode in an appropriate concentration within a range of the HPF detection number of 3,000 to 10,000. The HFP detection number within this range gives reproducible measurement values. Note, however, when producing toner base particles by an emulsion aggregation method, the step of wetting them in the surfactant aqueous solution described above and carrying out ultrasonic dispersion for 1 minute followed by dispersing them, can be omitted since the particles are fabricated in the wet process.

The circularity is calculated by the following expression.

$$\begin{matrix}\text{Circularity} = \left(\text{circumferential length of a circle having the same}\right) \\ \left(\text{projected area as a particle image}\right) / \left(\text{circumferential length of a}\right) \\ \left(\text{particle projected image}\right)\end{matrix}$$

### Resin for Convex Portions

A resin for convex portions preferably contains, for example, a vinyl resin and the like in a case in which a polyester resin is used as a resin for toner base particle precursors, and preferably contains a hybrid amorphous polyester resin and the like, in which a vinyl-based polymerization segment and a polyester-based polymerization segment are bonded via a bireactive monomer, in a case in which a vinyl resin is used as a resin for toner base particle precursors.

### 1) Hybrid Amorphous Polyester Resin

The “hybrid amorphous polyester resin” is a resin in which a vinyl-based polymerization segment composed of a styrene · acrylic-based polymer and the like and a polyester-based polymerization segment composed of an amorphous polyester resin are bonded via a bireactive monomer.

The resin for convex portions preferably contains a hybrid crystalline polyester resin. Copresence of a polyester-based polymerization segment and a vinyl-based polymerization segment with lower chargeability than the polyester-based polymerization segment in a convex portion, inhibits overcharge of toner particles and lowers electrostatic adhesion between the toner particles and a photoreceptor, thereby further enabling lowering of adhesion of foreign matters derived from toner on the photoreceptor. In addition, presence of the vinyl-based polymerization segment in a convex portion lowers electrostatic adhesion between the toner base particles and lubricant particles, facilitating supply of the lubricant particles onto the photoreceptor.

The vinyl-based polymerization segment refers to a polymer moiety obtained by polymerizing a vinyl-based monomer, and is preferably a polymer moiety obtained by polymerizing an aromatic vinyl-based monomer and a (meth)acrylic acid ester-based monomer.

In the present invention, the content of vinyl-based polymerization segment in a hybrid amorphous polyester resin is preferably, for example, within a range of 5 to 30% by mass and particularly preferably within a range of 10 to 20% by mass, relative to the total mass of the hybrid amorphous polyester resin. In addition, the hybrid amorphous polyester resin preferably contains the polyester-based polymerization segment within a range of, for example, 50 to 95% by mass.

The hybrid amorphous polyester resin containing the vinyl-based polymerization segment within a range of 5 to 30% by mass, makes it difficult for convex portions to be detached from toner base particles, enabling improvement in durability of the toner base particles. In addition, the hybrid amorphous polyester resin within the aforementioned range makes it difficult for convex portions to be merged with each other upon toner preparation as well as makes it difficult for a crystalline resin to be exposed on the surface of toner base particle precursors, thereby enabling sufficient effects as convex portions to be obtained.

The content of vinyl-based polymerization segment in a hybrid amorphous polyester resin refers to, specifically, a ratio of the mass of a vinyl-based monomer to be a vinyl-based polymerization segment to the total mass of resin materials used to synthesize the hybrid amorphous polyester resin, i.e., the total mass of polymerizable monomer forming an unmodified polyester resin to be a polyester-based polymerization segment, a vinyl-based monomer to be a vinyl-based polymerization segment, and a bireactive monomer that serves to bond these.

Moreover, the content of hybrid amorphous polyester resin in a toner base particle is preferably, for example, within a range of 5 to 20% by mass in the total amount of resins, in terms of achieving effects as convex portions without interfering with fixability.

From the viewpoint of low-temperature fixability, the hybrid amorphous polyester resin preferably has glass transition point Tg, for example, within a range of 50 to 70° C. and more preferably within a range of 50 to 65° C., and softening point Tsp thereof is preferably within a range of 80 to 110° C.

Glass transition point Tg of the hybrid amorphous polyester resin is a value measured by the method (DSC method) specified in ASTM (American Society for Testing and Materials) D3418-12el, and can be measured by the same measurement method as for the aforementioned resin for toner base particle precursors.

Moreover, softening point Tsp of the hybrid amorphous polyester resin can be measured in the same manner as for softening point Tsp of the aforementioned resin for toner base particle precursors.

### 2) Production Method of Hybrid Amorphous Polyester Resin

A method for producing a hybrid amorphous polyester resin employing conventional general schemes, can be used. Examples of representative methods include the following four methods from (A) to (D). Note, however, the following examples exemplify a case in which a vinyl-based polymerization segment is a polymer moiety obtained by polymerizing an aromatic vinyl-based monomer and a (meth)acrylic acid ester-based monomer.

(A) A method for preliminarily polymerizing a polyester-based polymerization segment, reacting the polyester-based polymerization segment with a bireactive monomer, and further reacting with an aromatic-based vinyl monomer and a (meth)acrylic acid ester-based monomer, for forming a vinyl-based polymerization segment, then to form a vinyl-based polymerization segment. That is, the method is a method for polymerizing an aromatic vinyl-based monomer and a (meth)acrylic acid ester-based monomer for forming a vinyl-based polymerization segment, in the presence of a bireactive monomer having a group capable of reacting with a polyvalent carboxylic acid monomer or a polyhydric alcohol monomer for forming a polyester-based polymerization segment and a polymerizable unsaturated group, and an unmodified polyester resin.

(B) A method for preliminarily polymerizing a vinyl-based polymerization segment, reacting the vinyl-based polymerization segment with a bireactive monomer, and further reacting with a polyvalent carboxylic acid monomer and a polyhydric alcohol monomer, for forming a polyester-based polymerization segment, then to form a polyester-based polymerization segment.

(C) A method for preliminarily polymerizing a polyester-based polymerization segment and a vinyl-based polymerization segment, respectively and reacting them with a bireactive monomer to bond both segments.

(D) A method for preliminarily polymerizing a polyester-based polymerization segment and reacting a polymerizable unsaturated group of the polyester-based polymerization segment with a vinyl-based polymerizable monomer by addition polymerization, or with a vinyl group in a vinyl-based polymerization segment, to bond both segments.

Here, the bireactive monomer is a monomer having a group capable of reacting with a polyvalent carboxylic acid monomer or a polyhydric alcohol monomer for forming a polyester-based polymerization segment of a hybrid amorphous polyester resin, and a polymerizable unsaturated group.

In describing the method (A) specifically, a vinyl-based polymerization segment can be formed at the end of a polyester-based polymerization segment through a mixing step of mixing an unmodified polyester resin for forming a polyester-based polymerization segment, an aromatic-based vinyl monomer and a (meth)acrylic acid ester-based monomer, and a bireactive monomer, and a polymerization step of polymerizing the aromatic-based vinyl monomer and the (meth)acrylic acid ester-based monomer in the presence of the bireactive monomer and the unmodified polyester resin. In this case, an ester bond is formed of a hydroxy group at the end of the polyester-based polymerization segment and a carboxy group of the bireactive monomer, and a vinyl group of the bireactive monomer bonds to a vinyl group of the aromatic-based vinyl monomer or the (meth)acrylic acid-based monomer, thereby from which the vinyl-based polymerization segment is bonded. Of the aforementioned synthesis methods, the method (A) is the most preferable.

In the mixing step described above, heating is preferred. A heating temperature may be favorably in the range in which an unmodified polyester resin, an aromatic-based vinyl monomer, a (meth)acrylic acid ester-based monomer, and a bireactive monomer can be mixed. Specifically, it is preferably, for example, within a range of 80 to 120° C., more preferably within a range of 85 to 115° C., and further preferably within a range of 90 to 110° C., from the viewpoint of enabling favorable mixing of those materials and facilitating control of polymerization.

A relative proportion of the aromatic-based vinyl monomer and the (meth)acrylic acid ester-based monomer is preferably such that glass transition temperature Tg calculated by the FOX formula represented by formula (i) below is within a range of 35 to 80° C. and preferably within a range of 40 to 60° C.

$$1 / \text{Tg} = \sum \left(\text{Wx} / \text{Tgx}\right) \qquad \text{Formula (i):}$$

wherein in formula (i) above, Wx represents the mass fraction of a monomer x, and Tgx represents a glass transition point of a homopolymer of monomer x.

In the present invention, the bireactive monomer shall not be used in calculation of the glass transition point.

A polymerization temperature in the polymerization step of polymerizing the aforementioned aromatic-based vinyl monomer and (meth)acrylic acid ester-based monomer is not particularly limited, and can be appropriately selected within the range in which the polymerization between the aromatic-based vinyl monomer and (meth)acrylic acid ester-based monomer and bonding to a polyester resin proceed. For example, the temperature is preferably within a range of 85 to 125° C., more preferably within a range of 90 to 120° C., and further preferably within a range of 95 to 115° C.

In a production of the hybrid amorphous polyester resin, volatile organic substances from emulsion of the residual monomer and the like after the aforementioned polymerization step, is practically preferably controlled to 1,000 ppm or less, more preferably 500 ppm or less, and further preferably 200 ppm or less.

### 2-1) Polyester-Based Polymerization Segment

A resin used to prepare a polyester-based polymerization segment constituting the hybrid amorphous polyester resin according to the present invention, is preferably obtained by polycondensation reaction in the presence of an appropriate catalyst using as raw materials a polyvalent carboxylic acid monomer (derivative) and a polyhydric alcohol monomer (derivative).

Polyvalent carboxylic acid monomers for use can be, for example, alkyl esters, acid anhydrides and acid chlorides of the polyvalent carboxylic acid monomers, and polyhydric alcohol monomers for use can be, for example, esters and hydroxycarboxylic acids of the polyhydric alcohol monomers.

Examples of the polyvalent carboxylic acid monomers include divalent carboxylic acids such as oxalic acid, succinic acid, maleic acid, mesaconic acid, adipic acid, β-methyladipic acid, azelaic acid, sebacic acid, nonane dicarboxylic acid, decanedicarboxylic acid, undecanedicarboxylic acid, dodecanedicarboxylic acid, fumaric acid, citraconic acid, diglycolic acid, cyclohexane-3,5-diene-1,2-dicarboxylic acid, malic acid, citric acid, hexahydroterephthalic acid, malonic acid, pimelic acid, tartaric acid, mucic acid, phthalic acid, isophthalic acid, terephthalic acid, tetrachlorophthalic acid, chlorophthalic acid, nitrophthalic acid, p-carboxyphenyl acetic acid, p-phenylene diacetic acid, m-phenylenediglycolic acid, p-phenylenediglycolic acid, o-phenylenediglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and dodecenyl succinic acid; trivalent or higher carboxylic acids such as trimellitic acid, pyromellitic acid, naphthalene tricarboxylic acid, naphthalene tetracarboxylic acid, pyrene tricarboxylic acid, and pyrene tetracarboxylic acid.

Of these, preferable for use as polyvalent carboxylic acid monomers, are unsaturated aliphatic dicarboxylic acids such as fumaric acid, maleic acid, and mesaconic acid, and particularly preferable for use is unsaturated aliphatic dicarboxylic acid represented by the general formula (A) above. Anhydrides of dicarboxylic acids such as maleic anhydride can also be used in the present invention.

Examples of polyhydric alcohol monomers include dihydric alcohols such as ethylene glycol, propylene glycol, butanediol, diethylene glycol, hexanediol, cyclohexanediol, octanediol, decanediol, dodecanediol, an ethylene oxide adduct of bisphenol A, and a propylene oxide adduct of bisphenol A; trivalent or higher polyols such as glycerin, pentaerythritol, hexamethylolmelamine, hexaethylolmelamine, tetramethylolbenzoguanamine, and tetraethylolbenzoguanamine.

In order to form the polyester-based polymerization segment constituting the hybrid amorphous polyester resin, according to the present invention, monomers free of a linear alkyl group as a polyvalent carboxylic acid and a polyhydric alcohol are preferably used.

A ratio of the polyvalent carboxylic acid monomer to the polyhydric alcohol monomer described above, for example, an equivalent ratio [OH]/[COOH] of a hydroxy group [OH] of the polyhydric alcohol monomer to a carboxy group [COOH] of the polyvalent carboxylic acid is preferably within a range of 1.5/1 to 1/1.5 and more preferably within a range of 1.2/1 to 1/1.2.

Catalysts used to synthesize a polyester-based polymerization segment, which are various types of conventionally known catalysts, can be used.

An amorphous polyester resin constituting the polyester-based polymerization segment preferably has glass transition point Tg, for example, within a range of 40 to 70° C. and more preferably within a range of 50 to 65° C. When glass transition point Tg of the amorphous polyester resin is 40° C. or higher, appropriate cohesive force of the amorphous polyester resin results in an elevated temperature region, inhibiting the occurrence of hot offset phenomenon upon fixation. The glass transition point of the amorphous polyester resin being 70° C. or lower makes it possible for the amorphous polyester resin to be sufficiently melted upon fixation and to sufficiently ensure the minimum fixation temperature.

A weight-average molecular weight Mw of the amorphous polyester resin is preferably, for example, within a range of 1,500 to 60,000 and more preferably within a range of 3,000 to 40,000. The weight-average molecular weight being 1,500 or more allows suitable cohesive force to be obtained as the entire toner base particle and inhibits the elevated-temperature offset phenomenon upon fixation. In addition, the weight-average molecular weight being 60,000 or less makes it possible to obtain a satisfactory melting viscosity and to sufficiently ensure the minimum fixation temperature, thereby inhibiting the lowered-temperature offset phenomenon upon fixation.

The amorphous polyester resin may have a partially branched structure, a cross-linked structure, or the like, formed by selecting a valence of carboxylic acid or that of alcohol and the like, as the polyvalent carboxylic acid monomer or polyhydric alcohol monomer used.

### 2-2) Bireactive Monomer

A bireactive monomer for forming a vinyl-based polymerization segment may be any monomer having a group capable of reacting with a polyvalent carboxylic acid monomer or a polyhydric alcohol monomer for forming a polyester-based polymerization segment and a polymerizable unsaturated group. Specifically, for example, acrylic acid, methacrylic acid, fumaric acid, maleic acid, maleic anhydride, and the like, can be used. In the present invention, acrylic acid or methacrylic acid is preferably used as the bireactive monomer.

A proportion of the bireactive monomer used is preferably, for example, within a range of 0.1 to 5.0% by mass and more preferably within a range of 0.5 to 3.0% by mass, when the total mass of the resin materials used, i.e., the total mass of an unmodified polyester resin, an aromatic-based vinyl monomer, a (meth)acrylic acid ester-based monomer, and the reactive monomer is 100%.

### 2-3) Vinyl-Based Polymerization Segment

The aromatic-based vinyl monomer and (meth)acrylic acid ester-based monomer for forming a vinyl-based polymerization segment are those having an ethylenically unsaturated bond capable of radical polymerization.

Examples of aromatic-based vinyl monomers include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, 3,4-dichlorostyrene, and derivatives thereof. These aromatic-based vinyl monomers can be used singly or in combinations with two or more thereof.

Examples of (meth)acrylic acid ester-based monomers includes methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate, and diethylaminoethyl methacrylate. These (meth)acrylic acid ester-based monomers can be used singly or in combinations with two or more thereof.

The aromatic-based vinyl monomer and (meth)acrylic acid ester-based monomer for forming a vinyl-based polymerization segment preferably use more styrene or its derivatives from the viewpoint of obtaining excellent chargeability and image quality characteristics. Specifically, the amount of styrene or its derivatives used is preferably, for example, 50% by mass or more of the total monomer (aromatic-based vinyl monomer and (meth)acrylic acid ester-based monomer) used for forming a styrene · acrylic-based polymer segment.

### 2-4) Polymerization Initiator

In the polymerization step of polymerizing the aromatic-based vinyl monomer and (meth)acrylic acid ester-based monomer described above, the polymerization is preferably carried out in the presence of a radical polymerization initiator. A timing of addition of the radical polymerization initiator is not particularly limited, but is preferably after a mixing step in terms of facilitation of control of radical polymerization.

Polymerization initiators which are various types of publicly known polymerization initiators are suitably used. Specific examples thereof include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, tert-hydroperoxide pertriphenylacetate, tert-butyl perfomate, tert-butyl peracetate, tert-butyl perbenzoate, tert-butyl perphenylacetate, tert-butyl permethoxyacetate, and tert-butyl perN-(3-toluyl)palmitate; azo compounds such as 2,2′-azobis(2-aminodipropane)hydrochloride, 2,2′-azobis(2-aminodipropane)nitrate, 1,1′-azobis(1-methylbutyronitrile-3-sodium sulfonate), 4,4′-azobis-4-cyanovaleric acid, and poly(tetraethylene glycol-2,2′-azobisisobutyrate). The amount of the polymerization initiator added varies depending on a desired molecular weight and molecular weight distribution, however, it is preferably, for example, within a range of 0.1 to 5.0% by mass relative to the polymerizable monomers.

### 2-5) Chain Transfer Agent

In the polymerization step of polymerizing the aromatic-based vinyl monomer and (meth)acrylic acid ester-based monomer described above, chain transfer agents generally used can be used for the purpose of adjusting a molecular weight of the styrene · acrylic-based polymer segment. The chain transfer agent is not particularly limited, and examples thereof include alkyl mercaptans and mercapto fatty acid esters.

The chain transfer agent is preferably mixed with a resin-forming material in the mixing step described above.

The amount of chain transfer agent added varies depending on a molecular weight and molecular weight distribution of a desired styrene · acrylic-based polymer segment, however, it is preferably, for example, within a range of 0.1 to 5.0% by mass, relative to the total mass of the aromatic-based vinyl monomer, (meth)acrylic acid ester-based monomer, and bireactive monomer.

### Average Long Side Length of Convex Portions

An average long side length of convex portions is preferably within a range of 100 to 500 nm and more preferably within a range of 100 to 300 nm from the viewpoint of lowering adhesion to other members and improving filming resistance.

In the present invention, the long side length of a convex portion and the average long side length of convex portions can be measured as follows. In image data photographed by a scanning electron microscope at a magnification of 10,000 times, convex portions are visually confirmed, a contour line is drawn for each individual convex portion, this contour line is sandwiched between two parallel lines, and when the distance between the two parallel lines becomes the maximum distance (X in FIG. 2), the distance is defined as a “long side length of a convex portion.” This measurement is carried out for 100 convex portions, the lengths of which are within a range of 30 to 2,000 nm, and the average value thereof is defined as an “average long side length of convex portions.”

### Average Density Distribution of Convex Portions

The average density distribution of convex portions is preferably within a range of 20 to 50 portions/µm² and more preferably within a range of 25 to 45 portions/µm². This enables lowering of adhesiveness of toner to other members as well as more reliably enables inhibition of toner particles from being slipped through because convex portions thereof are trapped between a photoreceptor surface and a cleaning blade.

In the present invention, the density distribution of convex portions and the average density distribution of convex portions can be measured as follows. In image data photographed by a scanning electron microscope at a magnification of 10,000 times, the number of convex portions with a long side length of 30 to 2,000 nm per unit surface area of each toner base particle is defined as the “density distribution of convex portions.” This measurement is carried out for 20 convex portions, the lengths of which are within a range of 30 to 2,000 nm, and the average value thereof is defined as the “average density distribution of convex portions.”

### <2.3 Lubricant Particle>

The toner particle according to the present invention is characterized in that it has at least one type of lubricant particle as an external additive, and that median diameter D2 of a lubricant particle with the smallest median diameter is average spacing D1 of convex portions on the surface of a toner base particle or larger.

The term “lubricant particle with the smallest median diameter” refers to, as described above, a type of lubricant particle provided that there is only one type of lubricant particle, or a type of lubricant particle with the smallest median diameter provided that there are plural types of lubricant particles.

The lubricant particle used herein is preferably fatty acid metal salt particle. Using a fatty acid metal salt particle that is positively charged as the lubricant particle, inhibits overcharge of toner and lowers electrostatic adhesion between a toner particle and a photoreceptor, thereby further enabling lowering of adhesion of foreign matters derived from the toner on the photoreceptor.

Fatty acid metal salts constituting fatty acid metal salt particles are preferably salts of metals selected from zinc, calcium, magnesium, aluminum, and lithium. Of these, particularly preferable is fatty acid zinc, fatty acid lithium or fatty acid magnesium. Fatty acids of the fatty acid metal salts are preferably higher fatty acids having 12 to 22 carbon atoms. The use of fatty acids having 12 or more carbon atoms can inhibit free fatty acid from being generated, and the fatty acids having 22 or less carbon atoms allow a melting point of the fatty acid metal salt not to become too high, thereby enabling favorable fixability to be obtained. The fatty acid is particularly preferably stearic acid.

Fatty acid metal salt particles used in the present invention are preferably zinc stearate particles or aluminum stearate particles. Of these, particularly preferable are zinc stearate particles because of their low adhesion to toner base particles.

Furthermore, when the fatty acid metal salt particles are used as lubricant particles, release ratio R of the fatty acid metal salt particle from a toner base particle in toner particles, as determined by an ultrasonic treatment method under the following conditions, is preferably within a range of 20 to 60%.

Release ratio R being 20% or more makes it possible for a moderate amount of lubricant particles that can lower toner adhesion to be supplied on a photoreceptor. Moreover, release ratio of 60% or less inhibits extreme release of lubricant particles, and inhibits excessive supply of lubricant particles onto a photoreceptor, thereby enabling inhibition of poor images such as lubricant memory.

### [Conditions of Ultrasonic Treatment Method]

Procedure 1: A NET intensity W1 of a metal element derived from fatty acid metal salt particles in toner particles is measured by X-ray fluorescence analysis.

Procedure 2: An aqueous dispersion of the toner particles is prepared.

Procedure 3: The aqueous dispersion prepared is subjected to ultrasonic treatment.

Procedure 4: The fatty acid metal salt particles released from toner base particles by ultrasonic treatment are removed.

Procedure 5: A NET intensity W2 of a metal element derived from the fatty acid metal salt particles in the toner particles from which the released fatty acid metal salt particles have been removed, is measured by X-ray fluorescence analysis.

Procedure 6: Release ratio R [%] is determined from the following formula (2):

$$\text{R} = \left(\text{W1-W2}\right) / \text{W1} \times 100 \qquad \text{Formula (2)}$$

For example, an X-ray fluorescence spectrometer “XRF-1700” (manufactured by Shimadzu Corporation) can be used in order to measure NET intensities W1 and W2 of a metal element derived from the fatty acid metal salt particles in Procedure 1 and Procedure 5. As a specific method for measuring the NET intensity, 2 g of toner particles is pressurized for 10 seconds with a load of 15 t and pelletized, and then can be measured by qualitative and quantitative analysis under the following conditions. A Kα peak angle of an element to be measured (metal element derived from fatty acid metal salt particles) can be determined from a 2θ table and used for the measurement.

-Measurement conditions-
Slit: Standard
Attenuator: None
Analyzing crystal (Ti = LiF, Si = PET)
Detector (Ti=SC, Si=FPC)

An aqueous dispersion of toner particles in Procedure 2 can be prepared, for example, by wetting 3 g of toner particles with 40 g of a 0.2% by mass aqueous solution of polyoxyethyl phenyl ether.

The ultrasonic treatment in Procedure 3 can be carried out, for example, by using an ultrasonic homogenizer “US-1200” (manufactured by NIHONSEIKI KAISHA Ltd.), adjusting ultrasonic energy so that an ammeter attached to the main unit indicates a vibration indication value of 60 µA (50 W), and applying it to the aqueous dispersion prepared in Procedure 2 for 2 minutes.

Fatty acid metal salt particles released from the toner base particles in Procedure 4 can be removed, for example, by using a filter with a mesh aperture of 1 µm followed by filtering the fatty acid metal salt particles and washing them with purified water.

The lubricant particles for use can be particles composed of calcium fluoride, boron nitride, molybdenum disulfide, tungsten disulfide, talc, kaolin, montmorillonite, mica, and the like, in addition to fatty acid metal salt particles.

The content of lubricant particles is not particularly limited, but is preferably within a range of 0.01 to 5.0% by mass and more preferably within a range of 0.05 to 2.0% by mass, relative to the total amount of toner base particles.

### <2.4 Non-Lubricant Particle>

The toner particle according to the present invention is characterized in that it has at least one type of non-lubricant particle as an external additive, and that median diameter D3 of a non-lubricant particle with the largest median diameter is average spacing D1 of convex portions on the surface of a toner base particle or smaller.

The “non-lubricant particle with the largest median diameter” refers to, as described above, one type of non-lubricant particle provided that there is only one type of non-lubricant particle, or a non-lubricant particle with the largest median diameter provided that there are plural types of non-lubricant particles.

The non-lubricant particle that is the inorganic fine particle and organic fine particle exemplified below, can be used.

Examples of inorganic fine particles include silica particles, titanium oxide particles, alumina particles, zirconia particles, zinc oxide particles, chromium oxide particles, cerium oxide particles, antimony oxide particles, tungsten oxide particles, tin oxide particles, tellurium oxide particles, manganese oxide particles, boron oxide particles, and strontium titanate particles. Of these, preferable are silica particles, titanium oxide particles, alumina particles, strontium titanate particles, and the like, with alumina particles being particularly preferable from the viewpoint of cost.

The inorganic fine particles are preferably subjected to hydrophobic treatment on the surface thereof, for which publicly known surface treatment agents are used. Examples of the surface treatment agents include a silane coupling agent, silicone oil, a titanate-based coupling agent, an aluminate-based coupling agent, fatty acids, fatty acid metal salts, esterified products thereof, and rosin acids. These surface treatment agents may be used singly or plural types thereof may be combined for use.

Examples of the aforementioned silane coupling agents include dimethyldimethoxysilane, hexamethyldisilazane (HMDS), methyltrimethoxysilane, isobutyltrimethoxysilane, and decyltrimethoxysilane. Examples of the above silicone oils include cyclic compounds, linear or branched organosiloxane, and the like, and more specific examples thereof include organosiloxane oligomers, octamethylcyclotetrasiloxane, decamethylcyclopentasiloxane, tetramethylcyclotetrasiloxane, and tetravinyltetramethylcyclotetrasiloxane.

Organic fine particles that are, for example, homopolymers of styrene, methyl methacrylate, and the like, or organic fine particles containing these copolymers thereof, can be used.

The toner particle according to the present invention is preferably a particle in which at least one type of non-lubricant particles is particles with a Mohs hardness of 8 or more. This increases adhesion of the non-lubricant particles, which are nucleus materials of deposits on a photoreceptor, to toner base particles and reduces the amount released, thereby further enabling lowering of the amount of deposits on the photoreceptor. The Mohs hardness of 8 or more renders no significant difference in its effect.

The Mohs hardness was proposed by F. Mohs. The Mohs hardness of particles can be measured using a publicly known Mohs hardness tester. Specifically, the particles are hardened by a pressure molding machine and then pelletized. Each of the following 10 minerals and the prepared pellet of the particles are rubbed against each other in turn, and when a pellet with a scratch is found, the hardness is determined to be lower than that of the mineral. The presence or absence of the scratch is determined by visual observation. The minerals are, in order from a lower hardness, 1: talc, 2: plaster 3: calcite, 4: fluorite, 5: phosphorite, 6: orthoclase, 7: quartz, 8: topaz, 9: corundum, 10: diamond. Note, however, the Mohs hardness is evaluated by a numerical value in increments of 0.5. For example, the Mohs hardness being 7 corresponds to a case where both of the pellet and quartz are scratched when the pellet is rubbed against quartz, and the Mohs hardness being 7.5 corresponds to a case where only quartz is scratched when the pellet is rubbed against quartz, and only the pellet is scratched when the object to be measured is rubbed against topaz.

The content of non-lubricant particles is not particularly limited, however, it is preferably within a range of 0.01 to 10.0% by mass and more preferably within a range of 0.05 to 5.0% by mass, relative to the total amount of toner base particles.

### <2.5 Other Parameters of Toner Particle>

### (Average Circularity of Toner Particles)

Average circularity of toner particles is preferably, for example, within a range of 0.940 to 0.980.

The average circularity of toner particles is an arithmetic mean value of circularity obtained by summing up circularity of each toner particle and dividing the obtained product by the total number of particles measured.

Circularity of a toner particle can be measured using a flow-type particle image analyzer “FPIA-2100” (manufactured by Sysmex Corporation). Specifically, toner particles are wetted in a surfactant aqueous solution, undergoing ultrasonic dispersion for 1 minute followed by dispersed, and then measured for circularity using the “FPIA-2100” in a measurement condition HPF (high magnification imaging) mode in an appropriate concentration within a range of the HPF detection number of 3,000 to 10,000. The HFP detection number within this range gives reproducible measurement values.

The circularity is calculated by the following expression.

$$\begin{matrix}\text{Circularity} = \left(\text{circumferential length of a circle having the same}\right) \\ \left(\text{projected area as a particle image}\right) / \left(\text{circumferential length of a}\right) \\ \left(\text{particle projected image}\right)\end{matrix}$$

### (Particle Size of Toner Particles)

The particle size of a toner particle is preferably, for example, within a range of 3 to 10 µm in terms of volume-based median diameter.

Setting the volume-based median diameter within the above range makes it possible, for example, to reliably reproduce very small dot images at the 1,200 dpi level.

The volume-based median diameter of a toner particle can be measured and calculated, for example, using an apparatus in which a computer system for data processing is connected to a Coulter Multisizer 3 (manufactured by Beckman Coulter, Inc.).

In the measurement procedure, 0.02 g of toner particles is thoroughly blended with 20 mL of a surfactant solution (for example, a surfactant solution in which a neutral detergent containing a surfactant component is diluted ten times with pure water, for the purpose of dispersing toner particles), and then the blended compound undergoes ultrasonic dispersion for 1 minute to prepare a toner particle dispersion. The toner particle dispersion is poured with a pipette into a beaker containing ISOTON II (manufactured by Beckman Coulter, Inc.) in a sample stand until a concentration to be measured falls within a range of 5 to 10% by mass, and measured by setting a measurement machine count at 25,000 units. Note, however, an aperture diameter of the Coulter Multisizer 3 that is 100 µm is used. The frequency count at the measurement range obtained by dividing a measurement range from 1 to 30 µm into 256, and the particle size at a 50% integrated value from the largest volume-integrated fraction is used as a volume-based median diameter.

### (Softening Point of Toner Particle)

Softening point Tsp of a toner particle is preferably, for example, within a range of 90 to 115° C. Softening point Tsp of the toner within this range results in favorable low-temperature fixability.

Softening point Tsp of a toner particle can be measured using a flow tester “CFT-500D” (manufactured by Shimadzu Corporation) in the same way as the aforementioned softening point Tsp of the resin for toner base particle precursors described above.

### <2.6 Production Method of Toner>

The toner according to the present invention can be produced by producing toner base particles and then adding an external additive.

The method for producing toner base particles can include, for example, a suspension polymerization method, an emulsion aggregation method, other publicly known methods, and the like, and is preferably used the emulsion aggregation method. The emulsion aggregation method can contemplate to facilitate micronization of the particle size of a toner particle in terms of production cost and production stability.

Here, the emulsion aggregation method is a method for mixing a dispersion of particles of a resin for toner base particle precursors, produced by emulsification, with a dispersion of particles of a coloring agent (hereinafter also referred to as “coloring agent particles”), as required, and allowing them to be aggregated until a desired particle size is achieved, and further controlling their shapes by fusing the resin particles with each other to produce toner base particles. Here, the particle of the resin for toner base particle precursors may optionally contain a mold release agent, a charge control agent, and the like.

A specific example of a method for producing toner base particles according to the present invention by the emulsion aggregation method will be described.
First step: Step of preparing a resin dispersion for toner base particle precursors, a resin dispersion for convex portions, a coloring agent-particle dispersion, and the like
Second step: Step of forming toner base particle precursors
Third step: Step of forming convex portions on the surface of the toner base particle precursors
Forth step: Step of cleaning and drying the toner base particles
Fifth step: Step of adding an external additive to the toner base particles

### First Step

In the first step, a resin dispersion for toner base particle precursors, a coloring agent dispersion, a resin dispersion for convex portions, and the like, are prepared.

### 1) Preparation of Resin Dispersion for Toner Base Particle Precursors.

A dispersion of resin particles for toner base particle precursors, containing a resin for toner base particle precursors and a mold release agent as required, is prepared.

The resin particles dispersion for toner base particle precursors can be prepared by emulsion polymerization in an aqueous medium.

The resin particle for a toner base particle precursor may have a multilayer structure of two or more layers composed of resins with different compositions. The resin particles with such a structure, for example, those having a two-layer structure can be obtained a method for preparing a dispersion of resin particles by emulsion polymerization treatment (first-stage polymerization) according to the usual method, adding a polymerization initiator and a polymerizable monomer to this dispersion, and subjecting the system to polymerization treatment (second-stage polymerization). A polymerizable monomer can be further added, as required to form a three-layer structure by third-stage polymerization.

The toner base particle according to the present invention may contain an internal additive such as a coloring agent, a charge control agent, or magnetic powder, as required, and such an internal additive can be introduced into a toner base particle, for example, by preliminarily dissolving or dispersing the internal additive in a monomer solution for forming resins for toner base particle precursors, in a polymerization step of this resin for toner base particle precursors.

Such an internal additive can also be introduced into a toner base particle by separately preparing a dispersion of internal additive particles composed only of the internal additive and allowing the internal additive particles to be aggregated together with resin particles for toner base particle precursors and coloring agent particles in the second step, however, a method for preliminarily introducing the internal additive into toner base particle precursors in a polymerization step of the resin for toner base particle precursors, is preferably employed.

A particle size of the resin particle for a toner base particle precursor in the dispersion preferably has a volume-based median diameter within a range of 50 to 500 nm in terms of controlling an average long side length and an average spacing of convex portions within the aforementioned ranges. The volume-based median diameter can be measured using a Coulter Multisizer 3 (manufactured by Beckman Coulter, Inc.).

### 2) Preparation of Resin Particles Dispersion for Convex Portions

Specific examples of methods for preparing a dispersion of resin particles for convex portions include a method for pulverizing resin particles for convex portions by a mechanical method and dispersing them in an aqueous medium using a surfactant, a method for feeding a resin solution for convex portions dissolved in an organic solvent into an aqueous medium and dispersing it to prepare an aqueous medium dispersion, a method for mixing a resin for convex portions in a molten state with an aqueous medium to prepare an aqueous medium dispersion by a mechanical dispersion method, and a phase-transfer emulsification method, however, any method may be used in the present invention.

A particle size of the resin particle for convex portions in the dispersion is preferably within a range of 50 to 500 nm in terms of a volume-based median diameter. The volume-based median diameter can be measured using a Coulter Multisizer 3 (manufactured by Beckman Coulter, Inc.).

### 3) Preparation of Coloring Agent Particles Dispersion

In a case in which a coloring agent is contained in toner base particles, a coloring agent particles dispersion is prepared. The coloring agent particles dispersion can be prepared by dispersing a coloring agent in an aqueous medium. The coloring agent preferably undergoes dispersion treatment in a surfactant concentration in the aqueous medium at the critical micelle concentration (CMC) or higher, because the coloring agent is uniformly dispersed. Various publicly known dispersing machines can be used for dispersion treatment of the coloring agent.

A particle size of the coloring agent particle in the dispersion is preferably within a range of 10 to 300 nm in terms of a volume-based median diameter. The volume-based median diameter can be measured using a Coulter Multisizer 3 (manufactured by Beckman Coulter, Inc.).

### Second Step

In the second step, toner base particle precursors are formed. Specifically, resin particles contained in a dispersion of resin particles for toner base particle precursors are aggregated to form toner base particle precursors.

In the second step, the resin particles for toner base particle precursors can be aggregated with particles of other toner constituents such as a charge control agent and coloring agent particles, as required. Therefore, a coloring agent particles dispersion and the like may be mixed with a resin particles dispersion for toner base particles precursors, as required, in the second step.

Incidentally, in the first step, the resin particles dispersion for toner base particle precursors may be such that they contain a mold release agent, however, in the first step, a mold release agent particles dispersion containing only the mold release agent may be separately prepared without containing the mold release agent in the resin particles for toner base particle precursors, and in the second step, the mold release agent particles dispersion may be mixed with the resin particles dispersion for toner base particles precursors.

A specific method for forming toner base particle precursors by aggregating resin particles contained in a dispersion of resin particles for toner base particle precursors is not particularly limited, however, includes a method for adding a flocculant to an aqueous medium in a concentration of the critical aggregation concentration or higher, then heating these mixture at a temperature of a glass transition temperature of the resin particles for toner base particle precursors or higher and the melting peak temperature of these mixture or lower, then to allow salting-out of particles such as resin particles for toner base particle precursors and coloring agent particles to proceed as well as to allow fusion to progress in parallel.

In this method, a time for allowing the flocculant to be stood undisturbed after it was added is as short as possible, and these mixture is preferably heated quickly at a temperature of glass transition point Tg of the resin particles for toner base particle precursors or higher and the melting peak temperature of these mixture or lower. The reason therefor is not clear, however, because there arises a concern that an aggregation state of the particles may vary depending on the time for being stood undisturbed after salting-out, resulting in problems of unstable particle size distributions and fluctuations in surface properties of the fused particles.

The time to start this temperature rise is normally preferably within 30 minutes. A rate of temperature rise is also preferably 1° C./min or faster. The upper limit of the rate of temperature rise is not particularly specified, however, it is preferably 10° C./min or slower from the viewpoint of inhibiting coarse particles from being generated due to rapid progress of fusion. Furthermore, after the reaction system reaches a temperature of the glass transition point or higher, it is necessary to maintain the temperature of the reaction system for a certain period of time to continue fusion. This allows growth and fusion of toner base particle precursors to proceed effectively, thereby enabling improvement in durability of toner particles to be finally obtained.

The toner base particle precursor is preferably created by aggregation and fusion of crystalline polyester resin particles and amorphous resin particles in the presence of metal ions. The crystalline polyester resin allowed to be finely dispersed inside toner can effectively demonstrate lower-temperature fixability. Moreover, the crystalline polyester resin is preferably absent on the surface of toner base particle precursors and the surface of toner base particles. Therefore, the crystalline polyester resin is preferably fed before toner base particle precursors grow, such as before or after addition of a flocculant, or when the reaction system reaches a desired temperature.

A flocculant used in the second step is not particularly limited, however one selected from metal salts is suitably used. Examples of the metal salts include monovalent metal salts such as salts of alkali metals such as sodium, potassium and lithium; divalent metal salts such as calcium, magnesium, manganese, and copper; trivalent metal salts such as iron and aluminum. Specific metal salts include sodium chloride, potassium chloride, lithium chloride, calcium chloride, magnesium chloride, zinc chloride, copper sulfate, magnesium sulfate, manganese sulfate, and the like, and of these, particularly preferable for use are divalent metal salts because they can promote aggregation in smaller quantities. They can be used singly or two or more thereof can be combined for use.

A particle size of a toner base particle precursor obtained in the second step is preferably, for example, within a range of 3 to 10 µm in terms of volume-based median diameter and more preferably within a range of 4 to 7 µm. The volume-based median diameter can be measured using a Coulter Multisizer 3 (manufactured by Beckman Coulter, Inc.).

### Third Step

In the third step, convex portions are formed on the surface of toner base particle precursors.

Specifically, a resin particles dispersion for convex portions is fed into an aqueous medium (reaction solution) of the toner base particle precursors that have grown to desired particle sizes in the second step, and the resin particles for convex portions are adhered to the toner base particle precursors. A pH of the aqueous medium (reaction solution) is then adjusted with a pH adjuster to cause fusion.

The specific method is a method for first adding a flocculant to an aqueous medium so that it reaches a critical aggregation concentration or higher, and then heating the mixture to a temperature of glass transition point Tg of resin particles for convex portions or higher and the peak melting temperature of these mixture or lower.

Next, a deflocculating agent is added to stop particle growth, when a supernatant of the aqueous medium becomes clear. Further, the temperature is raised and the mixture is heated and stirred at a temperature within a range of 80 to 90° C.

This allows for formation of plural convex portions on the surface of toner base particle precursors, enabling toner base particles to be formed. Next, the toner base particle precursors are cooled to a temperature within a range of 20 to 30° C. to obtain a dispersion of toner base particles with convex portions on the surface of toner base particle precursors.

In the third step, a fusion time for fusing the resin for convex portions onto toner base particle precursors is preferably within a range of 10 to 180 minutes and more preferably within a range of 30 to 120 minutes in terms of enabling the average long side length and average spacing of convex portions to be controlled within the range described above.

### Fourth Step

In the fourth step, the toner base particles are washed and dried. Various publicly known methods can be employed for washing and drying the toner base particles. In other words, a dispersion of toner base particles undergoes solid-liquid separation using a publicly known method such as a centrifugal machine, then the particles are washed, an organic solvent is removed by drying under reduced pressure, and further water and a small amount of the organic solvent are removed by a publicly known drying apparatus such as a flash jet dryer or a fluidized-bed dryer. A drying temperature is preferably within the range where toner is not fused.

### Fifth Step

In the fifth step, an external additive is added to toner base particles. Specifically, the external additive is added to the dried toner base particles followed by mixed together to form toner particles. In the present invention, at least one type of lubricant particle and at least one type of non-lubricant particle are used as the external additives.

A method for adding an external additive includes a dry method for adding an external additive in powder form to dried toner base particles, and pieces of mixing apparatus include pieces of mechanical mixing apparatus such as a Henschel mixer and a coffee mill.

### <2.7 Developer>

The toner according to the present invention may also be used as a magnetic or non-magnetic one-component developer, or may be mixed with a carrier and used as a two-component developer.

The carrier that is magnetic particles composed of conventionally known materials such as metals such as iron, ferrite and magnetite, and alloys of those metals with metals such as aluminum or lead, can be used, with ferrite particles being preferred among them. In addition, a coated carrier, in which the surface of magnetic particles is covered with a coating agent such as a resin, or a resin-dispersed carrier, in which magnetic fine powder is dispersed in a binder resin, may also be used as the carrier.

The carrier is preferably a carrier with a volume average particle size within a range of 15 to 100 µm and more preferably a diameter within a range of 25 to 80 µm.

### 3 Organic Photoreceptor

The organic photoreceptor used in the image forming system of the present invention is characterized in that it has a protective layer containing a cured resin.

A configuration of the organic photoreceptor according to the present invention is not particularly limited except that it has a protective layer containing a cured resin, and the configuration can be such that it has, for example, an intermediate layer on a conductive support, a photosensitive layer in which a charge generating layer containing a charge generating substance and a charge transport layer containing a charge transport substance are laminated in this order on the intermediate layer, and a protective layer on the photosensitive layer as an outermost layer. Note, however, the photosensitive layer may be such that it has a layer configuration with a monolayer structure containing the charge generating substance and the charge transport substance. The organic photoreceptor having such a configuration will be described in detail below.

### <3.1 Conductive Support>

The conductive support is a member that supports a photosensitive layer and has conductivity. Preferred examples of conductive supports include metal drums or sheets, plastic films with a laminated metal foil, plastic films with a film of vapor-deposited conductive substance, metal members or plastic films with a conductive layer coated with a conductive substance or paint composed of a conductive substance and a binder resin, and paper. Preferred examples of the metals described above include aluminum, copper, chromium, nickel, zinc and stainless steel, and preferred examples of the above conductive substances include the above metals, indium oxide, and tin oxide.

### <3.2 Photosensitive Layer>

The photosensitive layer is a layer used to form an electrostatic latent image of a desired image on the surface of a photoreceptor by means of exposure. The photosensitive layer may be a single layer or may be composed of a plurality of layers laminated on top of each other. Preferred examples of photosensitive layers include a single layer containing a charge transport substance and a charge generating substance, a laminate of a charge transport layer containing a charge transport substance and a charge generating layer containing a charge generating substance.

### <3.3 Protective Layer>

The protective layer is characterized in that it contains a cured resin. This improves a mechanical strength of a photoreceptor surface and increases scratch resistance and wear resistance.

### Cured Resin

The “cured resin” contained in the protective layer refers to a compound in which a polymerizable monomer is polymerized (cured) by irradiation with active energy rays such as ultraviolet rays, visible light rays, and electron beams, or by application of energy such as heating.

A type of polymerizable group of the polymerizable monomer to be a cured resin after curing is not particularly limited, but is preferably a radical polymerizable group. Here, the radical polymerizable group represents a radical polymerizable group having a carbon-carbon double bond. Examples of radical polymerizable groups include a vinyl group and a (meth)acryloyl group, with the (meth)acryloyl group being preferred. The polymerizable group being a (meth)acryloyl group improves wear resistance and a fog inhibiting effect of a protective layer. The reason for the improved wear resistance of the protective layer is conjectured to be that efficient curing is enabled with a small amount of light or in a short time.

Examples of polymerizable monomers to be a cured resin after curing include styrene-based monomers, (meth)acrylic-based monomers, vinyl toluene-based monomers, vinyl acetate-based monomers, and N-vinyl pyrrolidone-based monomers. These polymerizable monomers can be used singly or in a mixture of two or more thereof.

The number of polymerizable groups in one molecule of the polymerizable monomer is not particularly limited, but it is preferably two or more and more preferably three or more. The number of polymerizable groups within this range improves the wear resistance of a protective layer. The reason therefor is presumed to be that a crosslinking density of the protective layer increases and a film strength is further improved. Moreover, the number of polymerizable groups in one molecule of the polymerizable monomer is not particularly limited, but is preferably 6 or less, more preferably 5 or less, and further preferably 4 or less. The number of polymerizable groups within this range enhances uniformity of a protective layer and improves a fog inhibiting effect. The reason therefor is conjectured to be that the crosslinking density falls to a certain level or less, and shrinkage upon curing is less likely to occur. From these viewpoints, the number of polymerizable groups in one molecule of the polymerizable monomer is most preferably 3.

Specific examples of polymerizable monomers include without any particular limitations, the following compounds from M1 to M11, of which the following compound M2 is particularly preferred. In each of the following formulae, R represents an acryloyl group (CH₂═CHCO—) and R′ represents a methacryloyl group (CH₂═C(CH₃)CO—).

### [Formula 1]

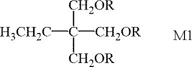

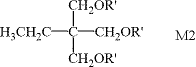

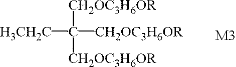

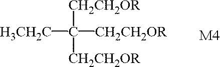

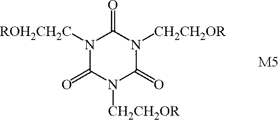

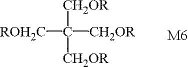

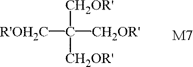

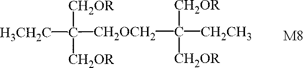

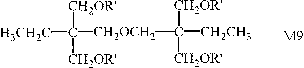

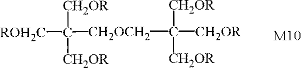

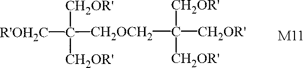

A charge transport compound having a polymerizable group can also be used as a polymerizable monomer forming a cured resin contained in a protective layer. This makes it possible to improve charge transportability as well as to improve wear resistance of an organic photoreceptor.

Examples of charge transport compounds having a polymerizable group include compounds having a structure with charge transportability as a basic backbone and having the radical polymerizable group described above as polymerizable groups, such as triarylamine derivatives, carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl derivatives, hydrazone derivatives, pyrazoline derivatives, oxazolone derivatives, benzimidazole derivatives, quinazoline derivatives, benzofuran derivatives, acridine derivatives, phenazine derivatives, aminostilbene derivatives, phenylenediamine derivatives, stilbene derivatives, and benzidine derivatives. Of these, preferable are compounds having a triarylamine derivative as a basic backbone and a (meth)acryloyl group as a polymerizable group.

The polymerizable monomers may be used singly or in combinations of two or more thereof. The polymerizable monomer may be synthetic or commercially available.

### Metal Oxide Particle

A protective layer preferably contains metal oxide particles. This inhibits wear and tear and further improves durability.

The “metal oxide particle” herein refers to a particle, the surface of which is composed of at least metal oxide. Examples of metal oxides constituting a metal oxide particle include, without any particular limitations, silicon oxide (silica), tin oxide, alumina, magnesium oxide, zinc oxide, lead oxide, tantalum oxide, indium oxide, bismuth oxide, yttrium oxide, cobalt oxide, copper oxide, manganese oxide, selenium oxide, iron oxide, zirconium oxide, germanium oxide, titanium oxide, niobium oxide, molybdenum oxide, vanadium oxide, copper aluminum oxide, and tin oxide doped with antimony ions. These metal oxide particles can be used singly or two or more thereof may be combined for use. The metal oxide particles may also be synthetic or commercially available.

Of these, more preferable are silicon oxide particles and tin oxide particles, with silicon oxide particles being further preferred.

A number-average primary particle size of metal oxide particles is preferably within a range of 50 to 500 nm, more preferably within a range of 65 to 400 nm, and further preferably within a range of 80 to 300 nm. The number-average primary particle size of the metal oxide particles being 50 nm or larger allows convex and concave due to the metal oxide particles to be appropriately imparted, thereby stabilizing a standing position of a cleaning blade upon cleaning, and improving cleanability. Moreover, the number-average primary particle size of the metal oxide particles being 500 nm or less, results in too large convex portions, which is unable to be caught on the cleaning blade, thereby leading to little risk of lowering cleanability accompanying occurrence of stick-slip of the blade.

It is noted that the number-average primary particle size of metal oxide particles is defined as the number-average primary particle size measured by the following method.

First, a 10,000-fold magnified photograph taken by a scanning electron microscope (manufactured by JEOL Ltd.) is captured on a scanner. Then, using the obtained photographic image, 300 particle images excluding aggregated particles, randomly undergo binarization processing using an automatic image processing and analysis system, Luzex (registered trademark) AP Software Ver. 1.32 (manufactured by Nireco Corporation), then to calculate a horizontal Feret diameter of each of the particle images. An average value of the horizontal Feret diameter of each of the particle images is then calculated as the number-average primary particle size. Here, the horizontal Feret diameter refers to the length of the side parallel to an x-axis of a bounding rectangle of the above particle image undergone binarization processing. Moreover, the number-average primary particle size of metal oxide particles shall be measured for metal oxide particles free of chemical species (covering layer) derived from a surface treatment agent.

The metal oxide particles are preferably surface treated with a surface treatment agent. The metal oxide particles surface treated with a surface treatment agent are considered to be covered particles containing a chemical species derived from the surface treatment agent (covering layer) and metal oxide particles. Note, however, the surface-treated metal oxide particles may at least partially have a chemical species (covering layer) derived from the surface treatment agent on the surface of the surface-treated metal oxide particles.

The surface treatment agents are not particularly limited, but include a silicone surface treatment agent having a silicone chain, a surface treatment agent having a polymerizable functional group, and the like, with a surface treatment agent having a silicone chain (hereinafter often also referred to as a silicone surface treatment agent) being preferred.

The silicone surface treatment agent is not particularly limited, but is preferably such that it has a silicone chain in a side chain of the polymer main chain, and is further preferably such that it has a reactive functional group. The reactive functional groups include a carboxy group, a hydroxy group, —R_{d}—COOH (R_{d} is a divalent hydrocarbon group), an alkyl silyl group, a halogenated silyl group, and an alkoxysilyl group that can bond to a metal oxide particle. Of these, preferable is a carboxyl group, a hydroxy group or an alkoxysilyl group.

The polymer main chain of the aforementioned silicone surface treatment agent is preferably a poly(meth)acrylate main chain or a silicone main chain, with a silicone main chain being more preferred. Metal oxide particles surface treated with a surface treatment agent having silicone chains in both the main chain and the side chain, have more silicone chains, thereby from which dispersibility in a protective layer is more enhanced and wear resistance of the protective layer is further improved.

The silicone chains of the side chain and main chain preferably have a dimethylsiloxane structure as a repeating unit, and the number of repeating units is preferably 3 to 100, more preferably 3 to 50, and further preferably 3 to 30.

A weight-average molecular weight of the silicone surface treatment agent is not particularly limited, but is preferably within a range of 1,000 to 50,000. The weight-average molecular weight of the silicone surface treatment agent can be measured by gel permeation chromatography (GPC).

The silicone surface treatment agent can be used singly or combined for use with two or more thereof. The silicone surface treatment agents may also be synthetic or commercially available. Specific examples of commercially available surface treatment agents with a silicone chain on a side chain of a poly(meth)acrylate main chain include Cymax (registered trademark) US-350 (manufactured by Toagosei Co Ltd) and KP-541, KP-574, and KP-578 (the above three are manufactured by Shin-Etsu Chemical Co., Ltd.). Specific examples of commercially available surface treatment agents with a silicone chain in a side chain of a silicone main chain include KF-9908 and KF-9909 (the above two are manufactured by Shin-Etsu Chemical Co., Ltd.).

The metal oxide particle described above is preferably a particle with a core-shell structure (composite particle), having a core composed of metal oxide and an outer shell material (shell) composed of a surface treatment agent. With increasing the particle size of a single particle having no core-shell structure, a refractive index difference from that of a polymerizable monomer becomes large, which reduces transmissiveness of active energy rays (especially UV light) used to cure a protective layer. As a result, a film strength of the protective layer after curing may become insufficient. Therefore, arranging a core material makes it possible to reduce a sea area by improving dispersibility and to secure a film strength by improving light transmission.

Materials constituting the core material (core) of the composite particle are not particularly limited, but include barium sulfate, alumina, silicon oxide, and the like. Of these, preferable is a particle with barium sulfate as a core material from the viewpoint of ensuring the light transmissiveness of the protective layer. Materials constituting the outer shell material (shell) of the composite particle are the same as those listed above as examples of metal oxides constituting the metal oxide particle. Preferred examples of composite particles with a core-shell structure include a composite particle having a core material composed of barium sulfate and an outer shell material composed of tin oxide. Note, however, a ratio of the number-average primary particle size of a core material to the thickness of an outer shell can be appropriately set according to types of core material and outer shell material used and combinations of these materials.

The method of surface treatment with a surface treatment agent is not particularly limited, and may be any method that allows the surface treatment agent to adhere (or bond) on the surface of metal oxide particles. Such methods are generally divided into two main types: a wet treatment method and a dry treatment method, either of which may be used.

Incidentally, in the case of surface treatment of metal oxide particles after the reactive surface treatment described below, a surface treatment agent adheres (or bonds) on the surface of metal oxide particles or on the reactive surface treatment agent.

The wet treatment method is a method in which metal oxide particles and a surface treatment agent are dispersed in a solvent to allow the surface treatment agent to adhere (or bond) to the surface of the metal oxide particles. The method is preferably a method for dispersing metal oxide particles and a surface treatment agent in a solvent, drying the resulting dispersion, and removing the solvent, and more preferably a method followed by further heat treatment to react the surface treatment agent with the metal oxide particles, thereby allowing the surface treatment agent to adhere (or bond) on the surface of the metal oxide particles. Moreover, after dispersing the surface treatment agent and the metal oxide particles in a solvent, the resulting dispersion may undergo wet pulverization to simultaneously progress surface treatment as well as micronization of the metal oxide particles.

Means of dispersing the metal oxide particles and the surface treatment agent in a solvent are not particularly limited, and publicly known means can be used, and examples thereof include general dispersing means such as homogenizers, ball mills, and sand mills.

A solvent is not particularly limited and any publicly known solvent can be used, and preferred examples thereof include alcohol-based solvents such as methanol, ethanol, n-propanol, isopropanol, n-butanol, sec-butanol (2-butanol), tert-butanol, benzyl alcohol, and aromatic hydrocarbon-based solvents such as toluene and xylene. They may be used singly or in combinations of two or more thereof. Of these, more preferable are methanol, 2-butanol, toluene, and a mixed solvent of 2-butanol and toluene.

A dispersion time is not particularly limited, and it is preferably, for example, within a range of 1 to 600 minutes, more preferably within a range of 10 to 360 minutes, and more preferably within a range of 30 to 120 minutes.

A method for removing a solvent is not particularly limited, and any publicly known method can be used, and examples thereof include a method for using an evaporator and a method for volatilizing the solvent under room temperature.

A heating temperature is not particularly limited, and is preferably within a range of 50 to 250° C., more preferably within a range of 70 to 200° C., and further preferably within a range of 90 to 150° C. A heating time is also not particularly limited, and is preferably within a range of 1 to 600 minutes, more preferably within a range of 10 to 300 minutes, and further preferably within a range of 30 to 90 minutes. Note, however, the heating method can be any publicly known method without any particular limitations.

The dry treatment method is a method for allowing a surface treatment agent to adhere (or bond) to the surface of conductive metal oxide by mixing and kneading the surface treatment agent and metal oxide particles, without using a solvent. The method may be a method for mixing and kneading the surface treatment agent and metal oxide particles followed by further carrying out heat treatment to react the surface treatment agent with the metal oxide particles, thereby allowing the surface treatment agent to adhere (or bond) on the surface of the metal oxide particles. In addition, the metal oxide particles may undergo dry pulverization to simultaneously progress micronization and surface treatment of the metal oxide particles, upon mixing and kneading the metal oxide particles and the surface treatment agent.

The amount of surface treatment agent used is preferably 0.1 part by mass or more, more preferably 1 part by mass or more, and further preferably 2 parts by mass or more, relative to 100 parts by mass of metal oxide particles before treatment (metal oxide particles after reactive surface treatment in the case of the surface treatment of metal oxide particles after the reactive surface treatment as described below). The amount within this range more enhances the wear resistance of the protective layer and the fog inhibiting effect.

Moreover, the amount of surface treatment agent used is preferably 100 parts by mass or less, more preferably 10 part by mass or less, and further preferably 5 parts by mass or less, relative to 100 parts by mass of metal oxide particles before surface treatment (metal oxide particles after reactive surface treatment in the case of the surface treatment of metal oxide particles after the reactive surface treatment as described below). The amount within this range inhibits lowering of the film strength of the protective layer due to an unreacted surface treatment agent and enhances the wear resistance of the protective layer.

Whether or not untreated metal oxide particles or metal oxide particles after reactive surface treatment were subjected to the surface treatment, can be confirmed by thermogravimetric and differential thermal analysis (TG/DTA) measurements, observation by a scanning electron microscope (SEM) or a transmission electron microscope (TEM), analysis by energy dispersive X-ray spectroscopy (EDX), and the like.

A surface-treated particle preferably has a group derived from a polymerizable group. The surface-treated particle having a group derived from a polymerizable group improves the wear resistance of the protective layer. The reason therefor is conjectured to be that the surface-treated particles and the polymerizable monomer are being chemically bonded in a cured material constituting the protective layer, thereby improving the film strength of the protective layer. A type of polymerizable group is not particularly limited, but a radical polymerizable group is preferable. A method for introducing the polymerizable group is not particularly limited, however, it is preferably a method for carrying out surface treatment of the metal oxide particles with a surface treatment agent having a polymerizable group.

Whether or not the surface-treated particles have a polymerizable group or the surface-treated particles in the protective layer have a group derived from the polymerizable group, can be confirmed by thermogravimetric and differential thermal analysis (TG/DTA) measurements, observation by a scanning electron microscope (SEM) or a transmission electron microscope (TEM), analysis by energy dispersive X-ray spectroscopy (EDX), mass analysis, and the like.

Metal oxide particles that have undergone the surface treatment (silicone surface treatment) described above are preferably further surface treated with a reactive surface treatment agent. The polymerizable group is supported on the surface of the metal oxide particles by the reactive surface treatment, resulting in that the surface-treated particles further have a polymerizable group. Then, the surface-treated particles polymerize with a polymerizable monomer via the polymerizable groups in the protective layer, forming a protective layer with a higher film strength that further improves the wear resistance of the protective layer. In this case, the silicone-surface treated particles are present in the protective layer as a structure with a group derived from the polymerizable group.

A reactive surface treatment agent has a polymerizable group and a reactive functional group. A type of polymerizable group is not particularly limited, but is preferably a radical polymerizable group. Here, the radical polymerizable group represents a radical polymerizable group having a carbon-carbon double bond. Examples of the radical polymerizable group include a vinyl group and a (meth)acryloyl group, of which preferable is a methacryloyl group. In addition, the reactive functional group represents a group having reactivity to polar groups such as a hydroxy group present on the surface of the metal oxide particles. Examples of reactive functional groups include a carboxyl group, a hydroxy group, —R′—COOH (R′ is a divalent hydrocarbon group), an alkyl silyl group, a halogenated silyl group, and an alkoxysilyl group. Of these, preferable are the alkyl silyl group, halogenated silyl group, and alkoxysilyl group.

The reactive surface treatment agent is preferably an silane coupling agent having a radical polymerizable group and examples thereof include compounds represented by the following formulae from S-1 to S-32.
S-1: CH₂═CHSi(CH₃)(OCH₃)₂
S-2: CH₂═CHSi(OCH₃)₃
S-3: CH₂═CHSiCl₃
S-4: CH₂═CHCOO(CH₂)₂Si(CH₃)(OCH₃)₂
S-5: CH₂═CHCOO(CH₂)₂Si(OCH₃)₃
S-6: CH₂═CHCOO(CH₂)₂Si(OC₂H₅)(OCH₃)₂
S-7: CH₂═CHCOO(CH₂)₃Si(OCH₃)₃
S-8: CH₂═CHCOO(CH₂)₂Si(CH₃)Cl₂
S-9: CH₂═CHCOO(CH₂)₂SiCl₃
S-10: CH₂═CHCOO(CH₂)₃Si(CH₃)Cl₂
S-11: CH₂═CHCOO(CH₂)₃SiCl₃
S-12: CH₂═C(CH₃)COO(CH₂)₂Si(CH₃)(OCH₃)₂
S-13: CH₂═C(CH₃)COO(CH₂)₂Si(OCH₃)₃
S-14: CH₂═C(CH₃)COO(CH₂)₃Si(CH₃)(OCH₃)₂
S-15: CH₂═C(CH₃)COO(CH₂)₃Si(OCH₃)₃
S-16: CH₂═C(CH₃)COO(CH₂)₂Si(CH₃)Cl₂
S-17: CH₂═C(CH₃)COO(CH₂)₂SiCl₃
S-18: CH₂═C(CH₃)COO(CH₂)₃Si(CH₃)Cl₂
S-19: CH₂═C(CH₃)COO(CH₂)₃SiCl₃
S-20: CH₂═CHSi(C₂H₅)(OCH₃)₂
S-21: CH₂═C(CH₃)Si(OCH₃)₃
S-22: CH₂═C(CH₃)Si(OC₂H₅)₃
S-23: CH₂═CHSi(OCH₃)₃
S-24: CH₂═C(CH₃)Si(CH₃)(OCH₃)₂
S-25: CH₂═CHSi(CH₃)Cl₂
S-26: CH₂═CHCOOSi(OCH₃)₃
S-27: CH₂═CHCOOSi(OC₂H₅)₃
S-28: CH₂═C(CH₃)COOSi(OCH₃)₃
S-29: CH₂═C(CH₃)COOSi(OC₂H₅)₃
S-30: CH₂═C(CH₃)COO(CH₂)₃Si(OC₂H₅)₃
S-31: CH₂═CHCOO(CH₂)₂Si(CH₃)₂(OCH₃)
S-32: CH₂═C(CH₃)COO(CH₂)₈Si(OCH₃)₃

The reactive surface treatment agents may be used singly or combined for use with two or more thereof. The reactive surface treatment agents may be synthetic or commercially available. Examples of the commercially available products include KBM-502, KBM-503, KBE-502, KBE-503, and KBM-5103 (all manufactured by Shin-Etsu Chemical Co. Ltd.).

In the case of carrying out both silicone surface treatment and reactive surface treatment, silicone surface treatment after the reactive surface treatment is preferably carried out. Carrying out the surface treatments in this order further improves the wear resistance of the protective layer. The reason therefor is due to the fact that a silicone chain, which has an oil-repellent effect does not prevent the reactive surface treatment agent from contacting the surface of metal oxide particles, thereby more effectively introducing a polymerizable group into the metal oxide particles.

A method of the reactive surface treatment is not particularly limited and can employ a method similar to that described for the silicone surface treatment, except that a reactive surface treatment agent is used. Publicly known surface treatment techniques for metal oxide particles may also be used.

In the case of using reactive surface treatment by a wet treatment method, a solvent is preferably methanol, ethanol and toluene, with methanol and toluene being more preferred.

The amount of reactive surface treatment agent used is preferably 0.5 parts by mass or more, more preferably 1 part by mass or more, and further preferably 1.5 parts by mass or more, relative to 100 parts by mass of metal oxide particles before reactive surface treatment. The amount within this range further improves the wear resistance of the protective layer and the fog inhibiting effect. The amount of reactive surface treatment agent used is also preferably 15 parts by mass or less, more preferably 10 parts by mass or less, and further preferably 8 parts by mass or less, relative to 100 parts by mass of metal oxide particles before the treatment. The amount within this range allows the amount of reactive surface treatment agent not to be excessive but to be within a more appropriate range, with respect to the number of hydroxy groups on the particle surface, thereby inhibiting lowering of a film strength of the protective layer due to an unreacted reactive surface treatment agent and further improving the wear resistance of the protective layer.

### Charge Transport Substance

The protective layer preferably contains a charge transport substance from the viewpoint of charge transportability of the organic photoreceptor.

The charge transport substance is not particularly limited, and can be any publicly known substance for use. Examples thereof include carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, pyrazoline compounds, oxazolone derivatives, benzimidazole derivatives, quinazoline derivatives, benzofuran derivatives, acridine derivatives, phenazine derivatives, aminostilbene derivatives, triarylamine derivatives, phenylenediamine derivatives, stilbene derivatives, and benzidine derivatives. Of these, preferable are triarylamine derivatives. The triarylamine derivatives are preferably those having the structure represented by the following general formula (1):

### [Formula 2]

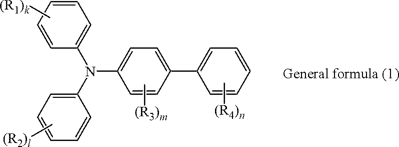

In the general formula (1) above, R₁, R₂, R₃ and R₄ each independently represent an alkyl group having 1 to 7 carbon atoms or an alkoxy group having 1 to 7 carbon atoms. k, l and n each independently represent an integer of 0 to 5 and m represents an integer of 0 to 4. Note, however, when k, l, m or n is 2 or more, the plurality of R₁, R₂, R₃ and R₄ present may be identical or different from each other. Of these, preferable are R₁, R₂, R₃ and R₄ each independently being an alkyl group having 1 to 3 carbon atoms. Preferably k, l, m and n are each independently an integer from 0 to 1.

A compound having the structure represented by the general formula (1) above can be, for example, a compound for use, described in JP2015-114454A, or it can be synthesized by publicly known synthetic methods, for example, the method disclosed in JP2006-143720A, and the like.

### Other Component

The protective layer may further contain other component other than those listed above. Examples of other components include lubricants without any particular limitations. The lubricant may be any publicly known lubricant for use without any particular limitations, and examples thereof include a polymerizable silicone compound, and a polymerizable perfluorinated polyether compound.

### <3.4 Production Method of Organic Photoreceptor>

The method for producing an organic photoreceptor is not particularly limited and can be produced by any publicly known method.

Of these, the organic photoreceptor is preferably produced by a method including a coating step of coating a surface of a photosensitive layer formed on a conductive support with a coating solution containing a resin composition for forming a protective layer; and a step of irradiating the coated resin composition for forming the protective layer with active energy rays or heating the coated resin composition for forming the protective layer to obtain a cured product of the resin composition for forming a protective layer.

The resin composition for forming a protective layer, for example, can contain a polymerizable monomer and a polymerization initiator for forming a cured resin, as well as metal oxide particles and a charge transport substance. The resin composition for forming a protective layer can also contain a dispersion medium.

The polymerization initiator is used to subject a polymerizable monomer to polymerization reaction. The polymerization initiator can be a thermal polymerization initiator or a photo polymerization initiator, but preferably a photo polymerization initiator. Moreover, in the case of the polymerizable monomer being a radical polymerizable monomer, a radical polymerization initiator is preferred. The radical polymerization initiator that is publicly known radical polymerization initiators can be used without any particular limitations, and examples thereof include an alkylphenone-based compound and a phosphine oxide-based compound. Of these, preferable are compounds having an α-aminoalkylphenone structure or acylphosphine oxide structure, and more preferable are compounds having an acylphosphine oxide structure. An example of the compound having an acylphosphine oxide structure includes IRGACURE (registered trademark) 819 (bis(2,4,6-trimethylbenzoyl)phenylphosphine oxide) (manufactured by BASF Japan Ltd.). The polymerization initiators may be used singly or in a mixture of two or more types thereof.

Any dispersion medium used for a resin composition for forming a protective layer can be used as long as it can dissolve or disperse a polymerizable monomer and the like. Specific examples thereof include methanol, ethanol, n-propanol, isopropanol, n-butanol, 2-butanol (sec-butanol), tert-butanol, benzyl alcohol, toluene, xylene, methyl ethyl ketone, cyclohexane, ethyl acetate, butyl acetate, methyl cellosolve, ethyl cellosolve, tetrahydrofuran, 1,3-dioxane, 1,3-dioxolane, pyridine, and diethylamine. The dispersion mediums can be used singly or in a mixture of two or more types thereof.

The content of a dispersion medium to the total mass of a resin composition for forming a protective layer is not particularly limited, however, it is preferably within a range of 1 to 99% by mass, more preferably within a range of 40 to 90% by mass, and further preferably within a range of 50 to 80% by mass%.

The content of a polymerizable monomer in a resin composition for forming a protective layer is not particularly limited, however, it is preferably 30% by mass or more, more preferably 40% by mass or more, and further preferably 50% by mass or more. The content within this range increases a crosslinking density of the protective layer and further improves wear resistance of the protective layer. Moreover, the content of a polymerizable monomer in a resin composition for forming a protective layer is preferably 80% by mass or less, more preferably 70% by mass or less, and further preferably 60% by mass or less.

The content of metal oxide particles in a resin composition for forming a protective layer is not particularly limited, however, it is preferably 20% by mass or more, more preferably 30% by mass or more, and further preferably 40% by mass or more. The content within this range increases a crosslinking density of the protective layer, further improves a mechanical strength, and further improves wear resistance of the protective layer. Moreover, the content of metal oxide particles in the resin composition for forming a protective layer is preferably 70% by mass or less, more preferably 60% by mass or less, and further preferably 50% by mass or less.

The content of a polymerization initiator in a resin composition for forming a protective layer is not particularly limited, however, it is preferably 0.1 parts by mass or more, more preferably 1 part by mass or more, and further preferably 5 parts by mass or more, relative to 100 parts by mass of the polymerizable monomer. The content within this range improves wear resistance of the protective layer. The content within this range increases a crosslinking density of a protective layer, further improves the mechanical strength, and further improves wear resistance of the protective layer. Moreover, the content of the polymerization initiator in a resin composition for forming a protective layer is preferably 40 parts by mass or less, more preferably 30 parts by mass or less, and further preferably 20 parts by mass or less, relative to 100 parts by mass of the polymerizable monomer.

A preparation method of a resin composition for forming a protective layer is also not particularly limited, and components such as a polymerizable monomer may be added to a dispersion medium and stirred and mixed until being dissolved or dispersed.

The protective layer of the organic photoreceptor according to the present invention can be formed by coating the surface of a photosensitive layer with the resin composition for forming a protective layer, prepared by the aforementioned method and drying and curing the coated layer.

In the process of coating, drying, and curing described above, reaction between polymerizable monomers, reaction between the polymerizable monomer and reactive surface-treated metal oxide particles, reaction between reactive surface-treated metal oxide particles, and the like, proceed then to form a protective layer including a cured product of the resin composition for forming a protective layer.

A coating method of a resin composition for forming a protective layer is not particularly limited, and publicly known methods such as a dip coating method, a spray coating method, a spinner coating method, a bead coating method, a blade coating method, a beam coating method, a slide hopper coating method, and a circular slide hopper coating method, can be employed.

After having been coated with the coating solution described above, natural drying or thermal drying is conducted to form a coated film, which is then irradiated with active energy rays to cure the coated film. Active energy rays that are ultraviolet rays and electron beams are preferred with the ultraviolet rays being more preferred.

A ultraviolet rays source that is a source generating ultraviolet rays, can be used without any particular limitations. For example, low-pressure mercury lamps, medium-pressure mercury lamps, high-pressure mercury lamps, ultra high-pressure mercury lamps, carbon arc lamps, metal halide lamps, xenon lamps, flash (pulse) xenon lamps, and the like, can be used. Irradiation conditions vary depending on each lamp, but an irradiation dose of ultraviolet rays (cumulative amount of light) is preferably 5 to 5,000 mJ/cm² and more preferably 10 to 2,000 mJ/cm². The illuminance of the ultraviolet rays is also preferably 5 to 500 mW/cm² and more preferably 10 to 100 mW/cm2.

An irradiation time to obtain a required irradiation dose (cumulative amount of light) of the active energy rays is preferably from 0.1 seconds to 10 minutes and more preferably from 0.1 seconds to 5 minutes from the viewpoint of working efficiency.

In a process of forming a protective layer, it can be dried before and after irradiation with active energy rays or during irradiation with active energy rays, and a timing of the drying can be appropriately selected in combinations thereof.

Drying conditions can be appropriately selected depending on a type of solvent, thickness, and the like. A drying temperature is preferably within a range of 20 to 180° C. and more preferably within a range of 80 to 140° C., and a drying time is preferably within a range of 1 to 200 minutes and more preferably within a range of 5 to 100 minutes.

A thickness of a protective layer is preferably within a range of 1 to 10 µm and more preferably within a range of 1.5 to 5 µm.

Components contained in the protective layer can be confirmed by publicly known analytical methods such as pyrolysis GC-MS, nuclear magnetic resonance (NMR), Fourier transform infrared spectrophotometry (FT-IR), elemental analysis, and the like.

### 4 Image Forming Apparatus

As described above, the apparatus section is specifically referred to as an “image forming apparatus” in the image forming system of the present invention.

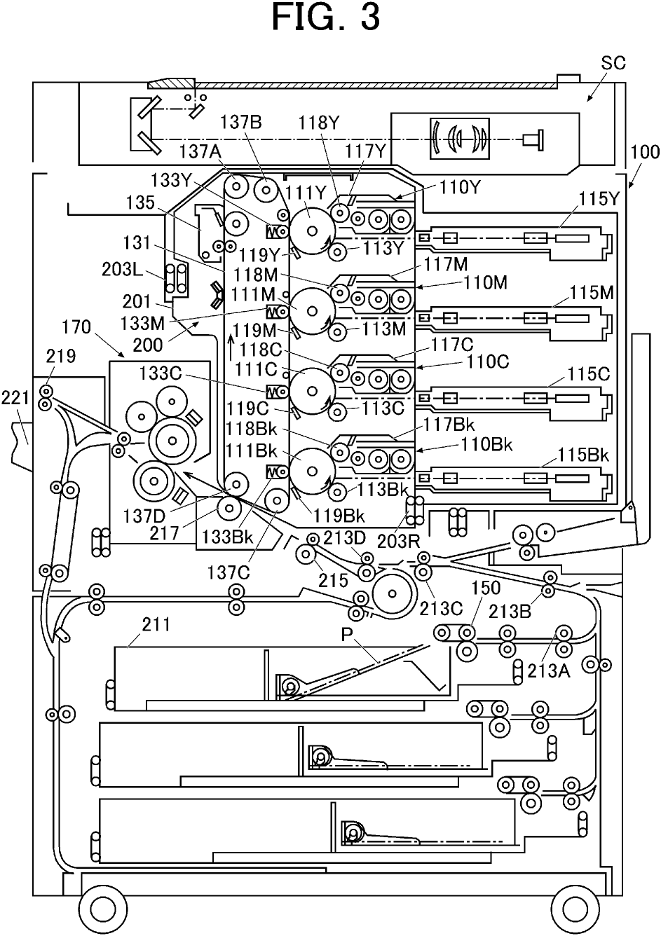

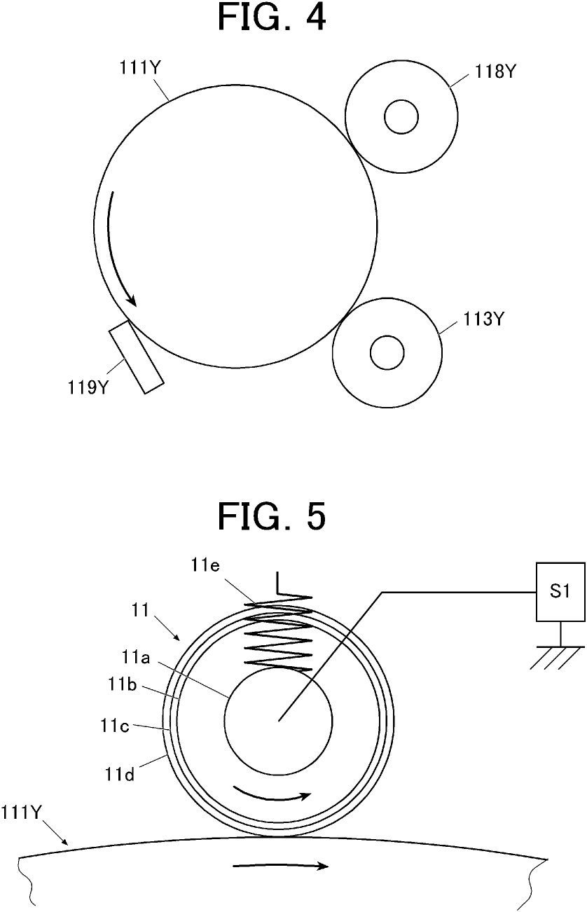

FIG. 3 is an explanatory cross-sectional view illustrating an example of a configuration of the image forming apparatus according to the present invention. FIG. 4 is also an explanatory cross-sectional view illustrating an example of a configuration of the key part of the image forming apparatus according to the present invention.

An image forming apparatus 100 shown in FIG. 3 is referred to as a tandem-type color image forming apparatus, and has four sets of image forming units 110Y, 110M, 110C, and 110Bk, a paper feed and conveyance means 150, and a fixation means 170.

A document image reader SC is arranged at the top of the main body of image forming apparatus 100.

Image forming units 110Y, 110M, 110C, and 110Bk are vertically arranged on top of each other.

Image forming units 110Y, 110M, 110C, and 110Bk have drum-shaped organic photoreceptors, 111Y, 111M, 111C, and 111Bk to be rotated, and charging means 113Y, 113M, 113C, and 113Bk, exposure means 115Y, 115M, 115C, and 115Bk, development means 117Y, 117M, 117C, and 117Bk, primary transfer rollers (primary transfer means) 133Y, 133M, 133C, and 133Bk, and cleaning means 119Y, 119M, 119C, and 119Bk, which are sequentially arranged along a rotation direction of organic photoreceptors in the outer circumference surface area of these organic photoreceptors.

The image forming apparatus has a configuration in which toner images of yellow (Y), magenta (M), cyan (C), and black (Bk), respectively, are formed on organic photoreceptors 111Y, 111M, 111C, and 111Bk.

Each configuration of the image forming apparatus other than the organic photoreceptor will be described below. In explaining them by using figures, an example of image forming unit 110Y will be used for explanation.

### <4.1 Charging Means>

The charging means (charger) is means that uniformly charges the surface of a photoreceptor.

The charging means used herein is preferably of a contact type or non-contact type roller charging type. The charging means of the roller charging type can significantly reduce the amount of ozone generated, and can also reduce an applied voltage compared to a corona charging type, thereby enabling an inhibiting effect of power consumption and space-saving.

A charging means 113Y shown in FIGS. 3 and 4 is of a contact-type roller charging type. Charging means 113Y in this example is composed of a charging roller arranged in contact with the surface of organic photoreceptor 111Y and a power supply that applies a voltage to the charging roller.

An example of a charging means of the contact-type roller charging type will be described. A charging roller 11 shown in FIG. 5 has a configuration in which a resistance control layer 11c for obtaining high uniform electrical resistance of charging roller 11 as a whole, is laminated, as required, on the surface of an elastic layer 11b laminated on the surface of a core metal 11a, in order to obtain uniform adhesiveness to organic photoreceptor 111Y with elasticity being imparted on layer 11b as well as to reduce charging noise, and a laminate in which a surface layer 11d is laminated on the resistance control layer 11c, is pressurized in the direction of organic photoreceptor 111Y by a pressure spring 11e and pressed against the surface of organic photoreceptor 111Y with a predetermined pressing force to form a charging nip section, and then charging roller 11 rotates driven by organic photoreceptor 111Yrotation.

Core metal 11a is made of metals such as iron, copper, stainless steel, aluminum and nickel, or those in which surfaces of these metals are plated to the extent that conductivity is not impaired in order to obtain rust resistance and scratch resistance, and an outer size thereof is, for example, within 3 to 20 mm.

Elastic layer 11b is composed of a layer such that conductive fine particles composed of carbon black, carbon graphite, or the like, or conductive fine particles composed of alkali metal salts, ammonium salts, or the like, are added, for example, in an elastic material such as rubber.

Specific examples of elastic materials include natural rubber, synthetic rubbers such as ethylene propylene diene methylene rubber (EPDM), styrene-butadiene rubber (SBR), silicone rubber, urethane rubber, epichlorohydrin rubber, isoprene rubber (IR), butadiene rubber (BR), nitrile-butadiene rubber (NBR), and chloroprene rubber (CR), resins such as a polyamide resin, a polyurethane resin, a silicone resin, and a fluororesin, or foams such as foam sponge. Elasticity can be adjusted by adding process oil, plasticizers, and the like to the elastic material.

A volume resistivity of elastic layer 11b is preferably within a range of 1 × 10¹ to 1 × 10¹⁰ Ω·cm. The volume resistivity of elastic layer 11b is a value measured in accordance with JIS K 6911.

A thickness of elastic layer 11b is preferably within a range of 500 to 5,000 µm and more preferably within a range of 500 to 3,000 µm.

Resistance control layer 11c is disposed for the purpose of allowing entire charging roller 11 to have uniform electrical resistance or the like, but it may be absent. Resistance control layer 11c can be arranged by coating it with a material with moderate conductivity or by covering it with a tube having moderate conductivity.

Specific materials constituting resistance control layer 11c include materials in which conductive agents such as conductive fine particles composed of carbon black, carbon graphite, or the like; conductive metal oxide fine particles composed of conductive titanium oxide, conductive zinc oxide, conductive tin oxide, or the like; or conductive fine particles composed of alkali metal salts, ammonium salts, or the like, are added in basis materials such as resins such as a polyamide resin, a polyurethane resin, a fluororesin, and a silicone resin; rubbers such as epichlorohydrin rubber, urethane rubber, chloroprene rubber, and acrylonitrile-based rubber, and the like.

A volume resistivity of resistance control layer 11c is preferably within a range of 1 × 10⁻² to 1 × 10¹⁴ Ω·cm and more preferably within a range of 1 × 10¹ to 1 × 10¹⁰ Ω·cm. The volume resistivity of resistance control layer 11c is a value measured in accordance with JIS K 6911.

A thickness of resistance control layer 11c is preferably within a range of 0.5 to 100 µm, more preferably within a range of 1 to 50 µm, and further preferably within a range of 1 to 20 µm.

Surface layer 11d is arranged for the purpose of preventing a plasticizer or the like in elastic layer 11b from bleeding out onto the surface of a charging roller obtained, for the purpose of obtaining slipperiness and smoothness of the surface of the charging roller, for the purpose of preventing leakage even in the case of presence of defects such as pinholes on organic photoreceptor 111Y, or the like, and surface layer 11d is arranged by being coated with a material with moderate conductivity or by being covered with a tube having moderate conductivity.

In a case in which surface layer 11d is arranged by being coated with a material, specific materials thereof include those in which conductive agents such as conductive fine particles composed of carbon black, carbon graphite, or the like; conductive metal oxide fine particles composed of conductive titanium oxide, conductive zinc oxide, conductive tin oxide, or the like; are added in basis materials such as resins such as a polyamide resin, a polyurethane resin, an acrylic resin, a fluororesin, and a silicone resin; epichlorohydrin rubber, urethane rubber, chloroprene rubber, and acrylonitrile-based rubber, and the like. Coating methods include a dip coating method, a roll coating method, a spray coating method, or the like.

Moreover, in the case of arranging surface layer 11d by being covered with a tube, specific tubes include materials formed into tube, such that the aforementioned conductive agent is added to nylon 12, a tetrafluoroethylene-perfluoroalkyl vinyl ether copolymer resin (PFA), polyvinylidene fluoride, a tetrafluoroethylene-6-fluoropropylene copolymer resin (FEP); a thermoplastic elastomer such as polystyrene-based, polyolefin-based, polyvinyl chloride-based, polyurethane-based, polyester-based, or polyamide-based elastomer. This tube may be heat shrinkable or non-heat shrinkable.

A volume resistivity of surface layer 11d is preferably within a range of 1 × 10¹ to 1 × 10⁸ Ω·cm and more preferably 1 × 10¹ to 1 × 10⁵ Ω·cm. The volume resistivity of surface layer 11d is a value measured in accordance with JIS K 6911.

A thickness of surface layer 11d is preferably within a range of 0.5 to 100 µm, more preferably within a range of 1 to 50 µm, and further preferably within a range of 1 to 20 µm.

Surface roughness of surface layer 11d is preferably within a range of 1 to 30 µm, more preferably within a range of 2 to 20 µm, and further preferably in the range of 5 to 10 µm.

In charging roller 11 as described above, application of a charging bias voltage to core metal 11a of charging roller 11 from power supply S1, charges the surface of organic photoreceptor 111Ya predetermined potential with predetermined polarity.

Here, the charging bias voltage may be, for example, a direct current voltage only, however, it is preferably an oscillating voltage in which an alternating current voltage is superimposed on the direct current voltage because of excellence in charge uniformity.

### <4.2 Exposure Means>

The exposure means is means that forms an electrostatic latent image corresponding to an image by light exposure based on an image signal on a photoreceptor given a uniform potential by the charging means.

Examples of the exposure means include those composed of LEDs and imaging elements with light-emitting elements arranged in an array in an axial direction of a photoreceptor, and those with laser optics.

### <4.3 Developing Means>

The developing means is means that supplies toner to the surface of a photoreceptor to develop an electrostatic latent image formed on the surface of the photoreceptor and to form a toner image.

Developing means 117Y shown in FIG. 3 is specifically composed of a developing roller 118Y, which incorporates a magnet and rotates holding a developer, and a voltage application apparatus (not shown) that applies direct current and/or alternating current bias voltages between organic photoreceptor 111Y and developing roller 118Y.

Toner is conveyed to organic photoreceptor 111Y by rotation of developing roller 118Y. A thin layer of toner on developing roller 118Y contacts organic photoreceptor 111Y to develop an electrostatic latent image on organic photoreceptor 111Y.

Developing roller 118Y is connected to a voltage application apparatus. This voltage application apparatus applies direct current and/or alternating current bias voltages to developing roller 118Y. The apparatus is configured such that, by controlling the voltage applied to developing roller 118Y, a developing bias can be adjusted to a desired value.

The potential difference (developing potential difference) between developing roller 118Y and a potential of the electrostatic latent image supported by organic photoreceptor 111Y forms an electric field in a developing section where developing roller 118Y and organic photoreceptor 111Y face each other.

Toner in a developer conveyed to a developing section by rotation of developing roller 118Y moves by action of force received from an electric field and is adsorbed onto an electrostatic latent image on organic photoreceptor 111Y. The electrostatic latent image supported on organic photoreceptor 111Y is visualized, thereby forming a toner image corresponding to a shape of the electrostatic latent image on the surface of organic photoreceptor 111Y.

### <4.4 Transfer Means>

The transfer means is means that transfers an toner image on an organic photoreceptor to a transfer body (intermediate transfer body or transfer material). In the case of using the intermediate transfer body, the primary transfer roller becomes a transfer means. Since the “transfer means” in the present invention is means that transfers a “toner image on a photoreceptor,” the secondary transfer roller used upon transferring it from an intermediate transfer body to a transfer material is not included in the “transfer means.”

Primary transfer roller 133Y shown in FIG. 3 transfers a toner image formed on organic photoreceptor 111Y to an intermediate transfer body 131 in the form of an endless belt. Primary transfer roller 133Y is disposed in contact with intermediate transfer body 131.

Image forming apparatus 100 shown in FIG. 3 employs an intermediate transfer method in which toner images formed on organic photoreceptors 111Y, 111M, 111C, and 111Bk are transferred to intermediate transfer body 131 by the primary transfer rollers (primary transfer means) 133Y, 133M, 133C, 133Bk, and each toner image transferred on intermediate transfer body 131 is transferred to a transfer material P by secondary transfer roller (secondary transfer means) 217, however, a direct transfer method in which a toner image formed on a photoreceptor is directly transferred to transfer material P by the transfer means may also be employed.

### <4.5 Cleaning Means>

A cleaning means 119Y is means that removes toner remaining on the surface of organic photoreceptor 111Y. Cleaning means 119Y in this example is composed of a cleaning blade. The cleaning blade is composed of a support member and a blade member supported on this support member via an adhesive layer. The blade member is disposed with its tip facing in a direction (counter direction) opposite to the direction of rotation of organic photoreceptor 111Y at a contact point with the surface of organic photoreceptor 111Y.

The support member that is conventionally known materials, can be used without any particular limitations, and examples thereof include those produced from rigid metals, elastic metals, plastics, and ceramics. Of these, rigid metals are preferred.

Blade members having, for example, a multi-layered structure in which a base layer and an edge layer are laminated, can be used. The base layer and the edge layer are each preferably composed of polyurethane. The polyurethanes include those obtained by reacting a polyol, a polyisocyanate, and a cross-linking agent as required.

Hereinafter, the present invention will be specifically described with reference to examples, but the present invention is not limited thereto. In the following examples, unless otherwise specified, the operations were performed at room temperature (25° C.). Unless otherwise specified, “%” and “part” mean “% by mass” and “parts by mass”, respectively.

### [Preparation of Vinyl Resin Particles Dispersion SA (1)]

### (First Stage Polymerization)

A 5 L reaction vessel equipped with a stirrer, a temperature sensor, a cooling pipe, and a nitrogen introduction apparatus, was charged with 8 parts by mass of sodium dodecyl sulfate and 3,000 parts by mass of ion-exchanged water, and the mixture was raised to an internal temperature of 80° C. while stirred at a stirring rate of 230 rpm under nitrogen gas flow. After the temperature rise, solution of 10 parts by mass of potassium persulfate dissolved in 200 parts by mass of ion-exchanged water was added, and the mixture was raised to a liquid temperature of 80° C. again, and a mixed solution of the following monomers was added dropwise over 1 hour.
Styrene 480.0 parts by mass
n-Butyl acrylate 250.0 parts by mass
Methacrylic acid 68.0 parts by mass
n-Octyl mercaptan 16.4 parts by mass

After the dropping, polymerization was carried out by heating and stirring at 80° C. for 2 hours to prepare a vinyl resin particles dispersion A.

### (Second Stage Polymerization)

A 5 L reaction vessel equipped with a stirrer, a temperature sensor, a cooling pipe, and a nitrogen introduction apparatus, was charged with solution of 7 parts by mass of sodium dodecyl sulfate dissolved in 3,000 parts by mass of ion-exchanged water, and the mixture was heated to 98° C. After heating, 300 parts by mass in terms of solids content, of vinyl resin particles dispersion A prepared by the aforementioned first-stage polymerization and a mixed solution of the following monomers, a chain transfer agent and a mold release agent, dissolved at 90° C., were added.

Styrene 243.0 parts by mass
n-Butyl acrylate 45.5 parts by mass
2-Ethylhexyl acrylate 45.5 parts by mass
Methacrylic acid 33.1 parts by mass
n-Octyl mercaptan 5.5 parts by mass
Behenyl behenate (mold release agent, melting point 73° C.) 130.0 parts by mass

A dispersion containing emulsified particles (oil droplets) was prepared by performing mixing and dispersing for 1 hour using a mechanical disperser with a circulation path, CLEARMIX (manufactured by M Technique Co., Ltd.). To this dispersion was added solution of a polymerization initiator in which 6 parts by mass of potassium persulfate was dissolved in 200 parts by mass of ion-exchanged water, and this system was heated and stirred for polymerization at 78° C. for 1 hour to prepare a vinyl resin particles dispersion B.

### (Third-Stage Polymerization)

To amorphous vinyl resin particles dispersion B obtained by the above second-stage polymerization were further added 400 parts by mass of ion-exchanged water, and the mixture was mixed well, and thereto was added solution of 6.0 parts by mass of potassium persulfate dissolved in 400 parts by mass of ion-exchanged water. Furthermore, a mixed solution of the following monomers and a chain transfer agent was added dropwise over a period of 1 hour under a temperature condition of 81° C.

Styrene 354.8 parts by mass
n-Butyl acrylate 143.2 parts by mass
Methacrylic acid 52.0 parts by mass
n-Octyl mercaptan 8.0 parts by mass

After completion of the dropping, the mixture was heated and stirred for polymerization for 2 hours, and then cooled down to 28° C. to prepare a vinyl resin particles dispersion SA (1).

### [Preparation of Vinyl Resin Particles Dispersion SA (2)]

A vinyl resin particles dispersion SA (2) was prepared in the same manner, except that the monomer mixed solution used in the first-stage polymerization in the preparation of vinyl resin particles dispersion SA (1) was changed to the following solution, which underwent polymerization reaction and post-reaction processing.
Styrene 624.0 parts by mass
n-Butyl acrylate 120.0 parts by mass
Methacrylic acid 56.0 parts by mass
n-Octyl mercaptan 16.4 parts by mass

### [Preparation of Crystalline Polyester Resin Particles Dispersion CP]

The following monomers were placed in a four-necked flask equipped with a nitrogen introduction tube, a dehydration tube, a stirrer and a thermocouple, and heated to 170° C.

Tetradecanedioic acid 440 parts by mass
1,6-Hexanediol 173 parts by mass

Next, 0.8 parts by mass of Ti(OBu)₄ was added as an esterification catalyst, and the mixture was raised to a temperature of 235° C., and was reacted under normal pressure (101.3 kPa) for 5 hours and further under reduced pressure (8 kPa) for 1 hour.

After cooling to 200° C., the mixture was then reacted under reduced pressure (20 kPa) for 1 hour to obtain a crystalline polyester resin 1.

The obtained crystalline polyester resin 1 had a weight-average molecular weight Mw of 20,500, an acid value of 22.1 mg KOH/g, and a melting point Tm of 75.2° C.

Next, 100 parts by mass of crystalline polyester resin 1 were dissolved in 400 parts by mass of ethyl acetate (manufactured by Kanto Chemical Industry Co., Ltd.) and mixed with 638 parts by mass of a sodium lauryl sulfate solution with a 0.26% by mass concentration that was preliminarily prepared. The mixed solution underwent ultrasonic dispersion treatment with an ultrasonic homogenizer US-150T (manufactured by NIHONSEIKI KAISHA L Ltd.) at V-LEVEL 300 µA for 30 minutes under stirring. Thereafter, a diaphragm vacuum pump V-700 (manufactured by BUCHI Labortechnik AG) was used while the mixed solution was heated to 40° C., and ethyl acetate was completely removed while being stirred for 3 hours under reduced pressure then to prepare a crystalline polyester resin particles dispersion CP. The crystalline polyester resin particles each in the dispersion had a volume-based median diameter of 160 nm.

### [Preparation of Hybrid Amorphous Polyester Resin Particles Dispersion HAP]

A mixed solution of the following vinyl resin monomer, a monomer having a substituent that reacted with both the amorphous polyester resin and the vinyl resin, and a polymerization initiator, was fed in a dropping funnel.

Styrene 80.0 parts by mass
n-Butyl acrylate 20.0 parts by mass
Acrylic acid 10.0 parts by mass
di-t-Butyl peroxide (polymerization initiator) 16.0 parts by mass

A four-neck flask equipped with a nitrogen introduction tube, a dehydration tube, a stirrer and a thermocouple, was added with the following monomers of an amorphous polyester resin, and the mixture was heated to 170° C. for dissolution.

An adduct of bisphenol A with 2 mol of ethylene oxide 59.1 parts by mass
An adduct of bisphenol A with 2 mol of propylene oxide 281.7 parts by mass
Terephthalic acid 63.9 parts by mass
Succinic acid 48.4 parts by mass

The mixed solution in the dropping funnel was added dropwise into the four-neck flask over 90 minutes under stirring, aging was performed for 60 minutes, and then the unreacted monomer was removed under reduced pressure (8 kPa). Thereafter, 0.4 parts by mass of Ti(OBu)₄ were added as an esterification catalyst, the mixture was raised to a temperature of 235° C., and reacted for 5 hours under normal pressure (101.3 kPa) and further for 1 hour under reduced pressure (8 kPa).

Next, the mixture was cooled down to 200° C. and reacted under reduced pressure (20 kPa), followed by desolvation to obtain a hybrid amorphous polyester resin (A1) modified by the vinyl resin.

The obtained hybrid amorphous polyester resin (A1) had a weight-average molecular weight Mw of 24,000, an acid number of 16.2 mg KOH/g, and a glass transition point Tg of 60° C.

Next, 100 parts by mass of hybrid amorphous polyester resin (A1) were dissolved in 400 parts by mass of ethyl acetate (manufactured by Kanto Chemical Industry Co., Ltd.) and mixed with 638 parts by mass of a sodium lauryl sulfate solution with a 0.26% by mass concentration that was preliminarily prepared. The mixed solution underwent ultrasonic dispersion treatment with an ultrasonic homogenizer US-150T (manufactured by NIHONSEIKI KAISHA Ltd.) at V-LEVEL 400 µA for 30 minutes under stirring. Thereafter, a diaphragm vacuum pump V-700 (manufactured by BUCHI Labortechnik AG) was used while the mixed solution was heated to 40° C., and ethyl acetate was completely removed while being stirred for 3 hours under reduced pressure then to prepare a hybrid amorphous polyester resin particles dispersion HAP with solids content of 13.5% by mass. The hybrid amorphous polyester resin particles each in the dispersion had a volume-based median diameter of 98 nm.

### [Preparation of Amorphous Polyester Resin Particles Dispersion AP]

A four-neck flask equipped with a nitrogen introduction tube, a dehydration tube, a stirrer and a thermocouple, was fed with the following monomers of an amorphous polyester resin, and the mixture was heated to 170° C. for dissolution.

An adduct of bisphenol A with 2 mol of ethylene oxide 59.1 parts by mass
An adduct of bisphenol A with 2 mol of propylene oxide 281.7 parts by mass
Terephthalic acid 63.9 parts by mass
Succinic acid 48.4 parts by mass

Under stirring, 0.4 parts of Ti(OBu)₄ was added as an esterification catalyst. After having been reacted at 235° C. under nitrogen gas flow for 6 hours, the mixture was cooled to 200° C., and further reacted for 5 hours under reduced pressure (20 kPa), followed by desolvation, then to obtain an amorphous polyester resin (B).

The obtained amorphous polyester resin (B) had a weight-average molecular weight Mw of 27,000, an acid value of 18.0 mg KOH/g, and a glass transition point Tg of 60° C.

100 parts by mass of amorphous polyester resin (B) were dissolved in 400 parts by mass of ethyl acetate (manufactured by Kanto Chemical Industry Co., Ltd.) and mixed with 638 parts by mass of a sodium lauryl sulfate solution with a 0.26% by mass concentration that was preliminarily prepared. The mixed solution underwent ultrasonic dispersion treatment with an ultrasonic homogenizer US-150T (manufactured by NIHONSEIKI KAISHA Ltd.) at V-LEVEL 400 µA for 30 minutes under stirring. Thereafter, a diaphragm vacuum pump V-700 (manufactured by BUCHI Labortechnik AG) was used while the mixed solution was heated to 40° C., and ethyl acetate was completely removed while being stirred for 3 hours under reduced pressure then to prepare an amorphous polyester resin particles dispersion AP with solids content of 13.5% by mass. The amorphous polyester resin particles each in the dispersion had a volume-based median diameter of 99 nm.

### [Preparation of Coloring Agent Particles Dispersion]

The following components were mixed and preliminarily dispersed in a homogenizer (ULTRA-TURRAX, manufactured by IKA-Werke GmbH & Co.KG) for 10 minutes, and then underwent dispersion treatment at a pressure of 245 MPa for 30 minutes using a high-pressure impact disperser, an ULTIMIZER (manufactured by SUGINO MACHINE LIMITED CO., LTD.).

Carbon black (REGAL 330, manufactured by Cabot Corporation) 100 parts by mass
Anionic surfactant (NEOGEN SC, Dai-ichi Kogyo Seiyaku Co., Ltd.) 15 parts by mass
Ion-exchanged water 400 parts by mass

To the obtained dispersion was further added ion-exchanged water, and the solids content was adjusted to 15% by mass then to prepare a coloring agent particles dispersion.

A volume-based median diameter of the coloring agent particle in the dispersion of the obtained coloring agent particles dispersion, was measured using a Coulter Multisizer 3 (manufactured by Beckman Coulter, Inc.), which was 110 nm.

### [Fabrication of Toner 1]

A reaction vessel equipped with a stirrer, a temperature sensor, and a cooling tube, was charged with 441 parts by mass(in terms of solids content) of vinyl resin particles dispersion SA1, 45 parts by mass (in terms of solids content) of crystalline polyester resin particles dispersion CP, 1% by mass as a resin ratio (in terms of solids content) of sodium dodecyldiphenyl ether disulfonate, and 200 parts by mass of ion-exchange water. A 5 mol/L sodium hydroxide solution was added at room temperature (25° C.) to adjust a pH to 11.

Furthermore, 40 parts by mass (in terms of solids content) of a coloring agent particles dispersion were added, and solution in which 40 parts by mass of magnesium chloride was dissolved in 40 parts by mass of ion-exchanged water was added over 15 minutes at 30° C. under stirring. The mixture was allowed to stand undisturbed for 5 minutes, and raised to a temperature of 85° C. over 90 minutes, and after having reached 85° C., a rate of stirring was adjusted so that a growth rate of particle size reached 0.02 µm/min, allowing the particles to grow until a volume-based median diameter measured by a Coulter Multisizer 3 (manufactured by Beckman Coulter, Inc.) reached 6.0 µm. The rate of stirring was adjusted when the diameter reached 6.0 µm, allowing particles to be fused together until average circularity of toner particles became 0.945 while growth of the particle size was being terminated. Toner base particle precursors were obtained thereby.

Next, 54 parts by mass (in terms of solids content) of hybrid amorphous polyester resin particles dispersion HAP were fed as a dispersion of a resin for convex portions over a period of 90 minutes, and when a supernatant of the reaction solution became clear, an aqueous solution in which 15 parts by mass of sodium chloride was dissolved in 60 parts by mass of ion exchanged water was added in order to inhibit a particle size from regrowing, allowing the particles to be fused together until the average circularity of the toner particles became 0.961. Thereafter the mixed solution was then cooled to 30° C. at a cooling rate of 2.5° C./min.

Thereafter, the mixed solution underwent solid-liquid separation, and a dehydrated toner cake was washed by repeating an operation of redispersing the dehydrated toner cake in ion-exchange water and subjecting the obtained dispersion to solid-liquid separation three times. After washing, the toner cake was dried at 35° C. for 24 hours then to obtain toner base particles having a plurality of convex portions formed on a surface thereof.

To 100 parts by mass of the obtained toner base particles were added 0.75 parts by mass of hydrophobic silica particles (volume-based median diameter: 12 nm, hydrophobicity: 68), 0.5 parts by mass of hydrophobic alumina particles (volume-based median diameter: 20 nm, hydrophobicity: 63, Mohs hardness: 8.5), and 0.4 parts by mass of sol-gel silica particles (1) (volume-based median diameter: 82 nm), as non-lubricant particles. In addition, 0.4 parts by mass of zinc stearate particles StZn (1) (volume-based median diameter: 1,210 nm) were added as lubricant particles, and mixed by a Henschel mixer (manufactured by Mitsui Miike Chemical Machinery Co., Ltd.) at 32° C. for 20 minutes with a peripheral speed of 40 mm/sec on a rotating blade. After mixing, coarse particles were removed using a sieve with a mesh opening of 45 µm to produce toner 1. Average spacing D1 of convex portions of the toner base particles in Toner 1 was 103 nm.

### [Production of Toner 2]

Toner 2 was produced in the same manner as Toner 1, except that a temperature upon feeding hybrid amorphous polyester resin particles dispersion HAP was appropriately changed. Average spacing D1 of convex portions of the toner base particles in Toner 2 was 198 nm.

### [Production of Toner 3]

Toner 3 was produced in the same manner as Toner 1, except that a temperature upon feeding hybrid amorphous polyester resin particles dispersion HAP was appropriately changed, and sol-gel silica particles (2) (volume-based median diameter: 48 nm) were added instead of sol-gel silica particles (1) as non-lubricant particles. Average spacing D1 of convex potions of the toner base particles in Toner 3 was 57 nm.

### [Production of Toner 4]

Toner 4 was produced in the same manner as Toner 1, except that a temperature upon feeding hybrid amorphous polyester resin particles dispersion HAP was appropriately changed, and sol-gel silica particles (3) (volume-based median diameter: 15 nm) were added instead of sol-gel silica particles (1) as non-lubricant particles. Average spacing D1 of convex portions of the toner base particles in Toner 4 was 20 nm.

### [Production of Toner 5]

Toner 5 was produced in the same manner as Toner 1, except that zinc stearate particles StZn(2) (volume-based median diameter: 5,370 nm) were added instead of zinc stearate particles StZn(1) as lubricant particles.

### [Production of Toner 6]

Toner 6 was produced in the same manner as Toner 1, except that zinc stearate StZn(3) (volume-based median diameter: 369 nm) was added instead of zinc stearate StZn(1) as lubricant particles.

### [Production of Toner 7]

Toner 7 was produced in the same manner as Toner 1, except that hydrophobic titania particles (volume-based median diameter: 20 nm, hydrophobicity: 61, Mohs hardness: 6.5) were added instead of hydrophobic alumina particles as non-lubricant particles.

### [Production of Toner 8]

Toner 8 was prepared in the same manner as Toner 1, except that amorphous polyester resin particles dispersion AP was added instead of hybrid amorphous polyester resin particles dispersion HAP as a dispersion of a resin for convex portions of toner base particles. Average spacing D1 of convex portions of the toner base particles in Toner 8 was 146 nm.

### [Production of Toner 9]

Toner 9 was produced in the same manner as Toner 1, except that vinyl resin particles dispersion SA(2) was fed instead of hybrid amorphous polyester resin particles dispersion HAP as a dispersion of a resin for convex portions of toner base particles. Average spacing D1 of convex portions of the toner base particles in Toner 9 was 292 nm.

### [Production of Toner 10]

Toner 10 was produced in the same manner as Toner 1, except that aluminum stearate particles StAl (volume-based median diameter: 1,580 nm) were added instead of zinc stearate particles StZn(1) as lubricant particles.

### [Production of Toner 11]

Toner 11 was produced in the same manner as Toner 1, except that calcium fluoride particles CaF₂(1) (volume-based median diameter: 210 nm) were added instead of zinc stearate particles StZn(1) as lubricant particles.

### [Production of Toner 12]

Toner 12 was produced in the same manner as Toner 1, except that hybrid amorphous polyester resin particles dispersion HAP was not fed as a dispersion of a resin for convex portions of toner base particles and no formation of convex portion resulted.

### [Production of Toner 13]

Toner 2 was produced in the same manner as Toner 1, except that a temperature upon feeding hybrid amorphous polyester resin particles dispersion HAP was appropriately changed. Average spacing D1 of the convex portions of the toner base particles in Toner 2 was 57 nm.

### [Production of Toner 14]

Toner 14 was produced in the same manner as Toner 2, except that calcium fluoride particles CaF₂(2) (volume-based median diameter: 105 nm) were added instead of zinc stearate particles StZn(1) as lubricant particles.

### [Release Ratio R of Fatty Acid Metal Salt Particles From Toner Base Particles in Each Toner]

Release ratio R of fatty acid metal salt particles from toner base particles in each toner was determined by an ultrasonic treatment method under the following conditions.

### [Conditions of Ultrasonic Treatment Method]

Procedure 1: A NET intensity W1 of a metal element derived from fatty acid metal salt particles in toner particles is measured by X-ray fluorescence analysis.

Procedure 2: An aqueous dispersion of the toner particles is prepared.

Procedure 3: The prepared aqueous dispersion undergoes ultrasonic treatment.

Procedure 4: The fatty acid metal salt particles released from toner base particles by ultrasonic treatment are removed.

Procedure 5: A NET intensity W2 of a metal element derived from the fatty acid metal salt particles in toner particles from which released fatty acid metal salt particles have been removed, is measured by X-ray fluorescence analysis.

Procedure 6: Release ratio R [%] is determined from the following formula (2).

$$\text{R} = \left(\text{W1 - W2}\right) / \text{W1} \times 100 \qquad \text{Formula (2)}$$

For the measurement of NET intensities W1 and W2 of a metal element derived from fatty acid metal salt particles in Procedures 1 and 5, an X-ray fluorescence analyzer “XRF-1700” (manufactured by Shimadzu Corporation) was used. As a specific measurement method of NET intensity, 2 g of toner particles was pressurized for 10 seconds with a load of 15 tons and pelletized, and measured by qualitative quantitative analysis under the following conditions. A Kα peak angle of an element to be measured (metal element derived from fatty acid metal salt particles) was determined from a 20 table and used in the measurement.

-Measurement conditions-
Slit: Standard
Attenuator: None
Spectroscopic crystal (Ti=LiF, Si=PET)
Detector (Ti=SC, Si=FPC)

The aqueous dispersion of toner particles in Procedure 2 was prepared by wetting 3 g of toner particles with 40 g of a 0.2% by mass aqueous solution of polyoxyethyl phenyl ether in a 100-mL plastic cup.

For the ultrasonic treatment in Procedure 3, an ultrasonic homogenizer “US-1200” (manufactured by NIHONSEIKI KAISHA Ltd.), was used, and ultrasonic energy was adjusted so that a value of an ammeter attached to the main unit, indicating a vibration indication value, was 60 µA (50 W), and the aqueous dispersion prepared in Procedure 2 underwent was applied for 2 minutes.

In removing the released fatty acid metal salt particles from toner base particles in Procedure 4, the particles were filtered using a filter with a mesh opening of 1 µm and washed with 60 mL of pure water. Furthermore, the toner particles were dried in preparation for the measurement in Procedure 5.

Release ratio R of the fatty acid metal salt particles from the toner base particles in each toner, determined by the aforementioned method is as shown in the table below.

TABLE 1

Table I

| Toner No. | Toner base particle | | | | | External additives | | | | | | |
|---|---|---|---|---|---|---|---|---|---|---|---|---|
| | Precursor | | Convex portion | | | Lubricant particle | | | Non-lubricant particle | | | |
| | Resin particles dispersion | Resin particles dispersion | Resin particles dispersion | Feed temperature | D1 [nm] | Type | D2 [nm] | Release ratio R[%] | Type | | | D3 [nm] |
| 1 | SA(1) | CP | HAP | Basis | 103 | StZn(1) | 1210 | 41 | Hydrophobic silica: 12 nm | Hydrophobic alumina: 20 nm, Mohs hardness: 8.5 | Sol-gel silica (1): 82 nm | 82 |
| 2 | SA(1) | CP | HAP | Changed as appropriate | 198 | StZn(1) | 1210 | 55 | Hydrophobic silica: 12 nm | Hydrophobic alumina: 20 nm, Mohs hardness: 8.5 | Sol-gel silica (1): 82 nm | 82 |
| 3 | SA(1) | CP | HAP | Changed as appropriate | 57 | StZn(1) | 1210 | 33 | Hydrophobic silica: 12 nm | Hydrophobic alumina: 20 nm, Mohs hardness: 8.5 | Sol-gel silica (2): 48 nm | 48 |
| 4 | SA(1) | CP | HAP | Changed as appropriate | 20 | StZn(1) | 1210 | 28 | Hydrophobic silica: 12 nm | Hydrophobic alumina: 20 nm, Mohs hardness: 8.5 | Sol-gel silica (3): 15 nm | 20 |
| 5 | SA(1) | CP | HAP | Basis | 103 | StZn(2) | 5370 | 68 | Hydrophobic silica: 12 nm | Hydrophobic alumina: 20 nm, Mohs hardness: 8.5 | Sol-gel silica (1): 82 nm | 82 |
| 6 | SA(1) | CP | HAP | Basis | 103 | StZn(3) | 369 | 36 | Hydrophobic silica: 12 nm | Hydrophobic alumina: 20 nm, Mohs hardness: 8.5 | Sol-gel silica (1): 82 nm | 82 |
| 7 | SA(1) | CP | HAP | Basis | 103 | StZn(1) | 1210 | 36 | Hydrophobic silica: 12 nm | Hydrophobic titania: 20 nm, Mohs hardness: 6.5 | Sol-gel silica (1): 82 nm | 82 |
| 8 | SA(1) | CP | AP | Basis | 146 | StZn(1) | 1210 | 38 | Hydrophobic silica: 12 nm | Hydrophobic alumina: 20 nm, Mohs hardness: 8.5 | Sol-gel silica (1): 82 nm | 82 |
| 9 | SA(1) | CP | SA(2) | Basis | 292 | StZn(1) | 1210 | 39 | Hydrophobic silica: 12 nm | Hydrophobic alumina: 20 nm, Mohs hardness: 8.5 | Sol-gel silica (1): 82 nm | 82 |
| 10 | SA(1) | CP | HAP | Basis | 103 | StAl | 1580 | 33 | Hydrophobic silica: 12 nm | Hydrophobic alumina: 20 nm, Mohs hardness: 8.5 | Sol-gel silica (1): 82 nm | 82 |
| 11 | SA(1) | CP | HAP | Basis | 103 | CaF₂(1) | 210 | 19 | Hydrophobic silica: 12 nm | Hydrophobic alumina: 20 nm, Mohs hardness: 8.5 | Sol-gel silica (1): 82 nm | 82 |
| 12 | SA(1) | CP | - | - | - | StZn(1) | 1210 | 71 | Hydrophobic silica: 12 nm | Hydrophobic alumina: 20 nm, Mohs hardness: 8.5 | Sol-gel silica (1): 82 nm | 82 |
| 13 | SA(1) | CP | HAP | Changed as appropriate | 57 | StZn(1) | 1210 | 41 | Hydrophobic silica: 12 nm | Hydrophobic alumina: 20 nm, Mohs hardness: 8.5 | Sol-gel silica (1): 82 nm | 82 |
| 14 | SA(1) | CP | HAP | Changed as appropriate | 198 | CaF₂(2) | 105 | 14 | Hydrophobic silica: 12 nm | Hydrophobic alumina: 20 nm, Mohs hardness: 8.5 | Sol-gel silica (1): 82 nm | 82 |

### [Production of Developer]

### <Production of Carrier Core Particle>

Raw materials used were weighed so that each mol% was as follows: MnO: 35 mol%, MgO: 14.5 mol%, Fe₂O₃: 50 mol%, and SrO: 0.5 mol%, mixed with water and then pulverized in a wet-type media mill for 5 hours to obtain slurry.

The resulting slurry was dried in a spray dryer to obtain spherical particles. Following adjustment of particle sizes of these particles, they were heated at 950° C. for 2 hours for pre-calcination. The particles were pulverized in a wet-type ball mill using stainless steel beads with a diameter of 0.3 cm for 1 hour, and then further pulverized using zirconia beads of 0.5 cm in diameter for 4 hours. PVA was added as a binder in an amount of 0.8% by mass relative to the solids content, then granulated and dried by a spray dryer, and finally held in an electric furnace at a temperature of 1,350° C. for 5 hours to be calcined.

The particles were then crushed, further classified to adjust particle sizes, and thereafter low-magnetic force products were separated by magnetic separation to obtain carrier core particles. A particle size of the carrier core particle was 35 µm.

### (Production of Covering Material)

Cyclohexyl methacrylate and methyl methacrylate at a “mass ratio of 5:5” (copolymerization ratio), were added in a 0.3% by mass aqueous solution of sodium benzenesulfonate, and potassium persulfate was added in an amount equivalent to 0.5% by mass of the total amount of monomers, and the mixture then underwent emulsion polymerization followed by spray drying to fabricate “covering material.” A weight-average molecular weight of the covering material obtained was 500,000.

### (Production of Carrier)

100 parts by mass of the “carrier core particles” prepared above as core particles and 4.5 parts by mass of the “covering material”, were fed in a high-speed mixer with horizontal stirring blades, and mixed and stirred at 22° C. for 15 minutes under conditions where a peripheral speed of the horizontal rotating blades was 8 m/sec followed by mixed for 50 minutes at 120° C., and then the surface of the core particles was covered with the covering material by action of mechanical impact force (mechanochemical method) to produce a “carrier.”

### (Mixing of Toner and Carrier)

The above prepared toners and the carriers were each mixed for 30 minutes so that a toner concentration was 6.5% by mass to produce each developer containing each toner. A V-type mixer was used as a mixer.

### [Fabrication of Organic Photoreceptor 1]

### (Preparation of Conductive Support)

A surface of a cylindrical aluminum support was cut and machined to prepare a conductive support.

### (Formation of Intermediate Layer)

The following components were mixed in the following amounts and dispersed for 10 hours in batchwise manner using a sand mill as a disperser to prepare a coating solution for forming an intermediate layer. A surface of a conductive support was coated with the coating solution by a dip coating method, and the coated film was dried at 110° C. for 20 minutes to form an intermediate layer with a thickness of 2 µm on the conductive support. Note, however, an X1010 (manufactured by Daicel-Evonik Ltd.) was used as a polyamide resin, and a SMT-500SAS (number-average primary particle size: 0.035 µm, manufactured by TAYCA CORPORATION) was used as titanium oxide particles.

Polyamide resin 10 parts by mass
Titanium oxide particles 11 parts by mass
Ethanol 200 parts by mass

### (Formation of Charge Generating Layer)

The following components were mixed in the following amounts and dispersed using a circulation-type ultrasonic homogenizer (RUS-600TCVP, manufactured by NIHONSEIKI KAISHA Ltd.) at 19.5 kHz, 600 W, and a circulation flow rate of 40 L/hour for 0.5 hours, then to prepare a coating solution for forming a charge generating layer. A surface of an intermediate layer was coated with the resulting coating solution by a dip coating method and air-dried to form a charge generating layer with a thickness of 0.3 µm on the intermediate layer. Note, however, the charge generating substance for use was an eutectic of titanyl phthalocyanine, which has clear peaks at 8.3°, 24.7°, 25.1°, and 26.5° in Cu-Kα characteristic X-ray diffraction spectrum measurement, as well as a titanyl phthalocyanine adduct of (2R,3R)-2,3-butanediol at 1:1 ratio and a titanyl phthalocyanine non-adduct. In addition, Eslec (registered trademark) BL-1 (manufactured by Sekisui Chemical Co., Ltd.) was used as a polyvinyl butyral resin. Further, a mixed solvent that is 3-methyl-2-butanone/cyclohexanone = 4/1 (volume ratio), was used.
Charge generating substance 24 parts by mass
Polyvinyl butyral resin 12 parts by mass
Mixed solvent 400 parts by mass

### (Formation of Charge Transport Layer)

A surface of the charge generating layer was coated with a coating solution for a charge transport layer, mixed with the following components in the following amounts by the dip coating method, and the coated film was dried at 120° C. for 70 minutes to form a charge transport layer with a thickness of 24 µm on the charge generating layer. Iupilon (registered trademark) Z300 (bisphenol Z-type polycarbonate, manufactured by Mitsubishi Gas Chemical Company, Inc.) was used as a polycarbonate resin. IRGANOX (registered trademark) 1010 (manufactured by BASF Japan Ltd.) was used as an antioxidant.
A charge transport substance represented by CTM-(1) below 60 parts by mass
A polycarbonate resin 100 parts by mass
THF (tetrahydrofuran) 800 parts by mass
Toluene 200 parts by mass
An antioxidant 4 parts by mass

### [Formula 3]

CTM-(1)

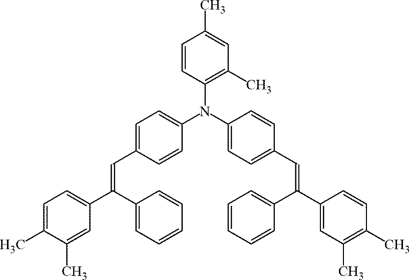

### (Formation of Protective Layer)

A surface of the charge transport layer was coated with a coating solution for forming a protective layer, mixed with the following components in the following amounts, using a circular slide hopper coating machine. The resulting film of the coating solution was irradiated with ultraviolet rays (main wavelength: 365 nm) using a metal halide lamp for 1 minute (ultraviolet rays illuminance: 16 mW/cm², cumulative amount of light: 960 mJ/cm²) to cure the film, thereby forming a protective layer with a thickness of 3.0 µm on the charge transport layer. A polymerization initiator used was IRGACURE (registered trademark) 819 (manufactured by BASF Japan Ltd.).
A polymerizable monomer represented by chemical formula M2 above 120 parts by mass
Tin oxide particles 100 parts by mass
A polymerization initiator 10 parts by mass
2-butanol 400 parts by mass
THF (tetrahydrofuran) 100 parts by mass
A charge transport substance represented by CTM-(1) above 30 parts by mass

Organic photoreceptor 1 was thus prepared thereby.

### [Fabrication of Organic Photoreceptor 2]

Organic photoreceptor 2 was fabricated in the same way as organic photoreceptor 1, except that metal oxide particles to be mixed in the coating solution for forming a protective layer were changed from the tin oxide particles to silicon oxide particles.

### [Fabrication of Organic Photoreceptor 3]

Organic photoreceptor 3 was fabricated in the same way as organic photoreceptor 1, except that the tin oxide particles were not mixed in the coating solution for forming a protective layer.

### [Fabrication of Organic Photoreceptor 4]

Organic photoreceptor 4 was fabricated in the same way as organic photoreceptor 1, except that no polymerization initiator was mixed in the coating solution for forming a protective layer, and the film of the coating solution for forming a protective layer was cured by electron beam irradiation instead of ultraviolet rays.

### [Fabrication of Organic Photoreceptor 5]

Organic photoreceptor 5 was fabricated in the same way as organic photoreceptor 1, except that fabrication of a protective layer was changed to the following manner.

### (Fabrication of Protective Layer in Organic Photoreceptor 5)

A surface of the charge transport layer was coated with a coating solution for forming a protective layer, mixed with the following components in the following amounts, using a circular slide hopper coating machine, and the coated film was dried at 120° C. for 70 minutes to form a protective layer with a thickness of 3.0 µm on the charge transport layer. Note, however, Iupilon (registered trademark) Z300 (bisphenol Z-type polycarbonate, manufactured by Mitsubishi Gas Chemical Company, Inc.) was used as a polycarbonate resin. Moreover, IRGANOX (registered trademark) 1010 (manufactured by BASF Japan Ltd.) was used as an antioxidant.
A charge transport substance represented by CTM-(1) above 60 parts by mass
A polycarbonate resin 100 parts by mass
THF (tetrahydrofuran) 1,600 parts by mass
Toluene 400 parts by mass
An antioxidant 4 parts by mass

### [Image Forming System]

A “bizhub C650i” (manufactured by KONICA MINOLTA, INC.), a commercially available full-color multifunction printer employing a contact-type roller charging type, was used as each image forming system, with the organic photoreceptors and developers fabricated as described above, mounted in a cyan position in combinations thereof listed in the table below. Evaluation of each image forming system will be described below.

### [Evaluation of Amount of Wear and Tear Α Value]

An endurance test for 300,000 prints was conducted in a normal temperature and humidity environment (20° C., 50% RH) on A4 size neutral paper with a chart printed by 5%. Thicknesses of the protective layer of the organic photoreceptor were measured before and after the endurance test to calculate and evaluate the amount of wear and tear. Thicknesses of the protective layer were measured at 10 locations randomly selected, with a uniform thickness (excluding locations with variation of thicknesses at a leading edge and trailing edge of a coating) by using a film thickness gauge, and an average value thereof was used as a thickness of the protective layer. An eddy current type film thickness gauge, “EDDY560C” (manufactured by Helmut Fischer GmbH + CO KG) was used as the film thickness gauge. Difference in thicknesses of the protective layer before and after the durability test was defined as the amount of wear and tear. The amount of wear and tear (µm) per 100 krot (100,000 rpm) was defined as an α value and described. The results are shown in the table below. The α value of 1.2 or less was considered satisfactory for practical use, and the α value of 0.7 or less was considered further favorable.

### [Evaluation of Deposits on Organic Photoreceptor]

An endurance test for 5,000 prints was conducted on A4 size neutral paper with a 5% printed chart, in a normal temperature and humidity environment (20° C., 50% RH) After the endurance test, the surface of the organic photoreceptor was observed under a microscope, and the total number of deposits derived from a developer was measured in 20 mm × 40 mm fields of view in three locations at the back, center, and front thereof. The results are shown in the table below. The total number of deposits with 10 or less was determined to be no problematic in terms of quality.

### [Image Evaluation]

A3 size neutral paper with a halftone image in a front portion thereof and a white background in the rear portion in the conveyance direction of the paper, a coverage of which is 80%, was printed, in an environment of 10° C. and humidity of 15% RH, for 20,000 sheets. The white background of the 20,000th sheet of paper was visually observed and evaluated for stains due to toner pass-through based on the following criteria. The evaluation results are shown in the table below. The evaluation results of “AA” and “A” were determined to be acceptable.
AA: No stain occurred on a white background.
A: Streak stains slightly occurred on the white background, but not practically problematic.
B: Obvious streak stains occurred on the white background, being practically problematic.

TABLE 2

Table II

| Image forming system No. | Organic photoreceptor | | | Toner | | | | | | | | Evaluation | | | Remarks |
|---|---|---|---|---|---|---|---|---|---|---|---|---|---|---|---|
| | Organic photoreceptor No. | Protective layer | | Toner No. | Toner base particle | | External additives | | | | | Wear and tear amount α value | Deposits on organic photoreceptor | Image evaluation | |
| | | Resin | Metal oxide particle | | Convex portion | | Lubricant particle | | | Non-lubricant particle | | | | | |
| | | | | | Resin | D1 [nm] | Type | D2 [nm] | Release ratio B[%] | D3 [nm] | Mohs hardness | | | | |
| 1 | 1 | Ultraviolet curable | Silicon oxide | 1 | HAP | 103 | StZn(1) | 1210 | 41 | 82 | 8.5 | 0.51 | 0 | AA | Present invention |
| 2 | 1 | Ultraviolet curable | Silicon oxide | 2 | HAP | 198 | StZn(1) | 1210 | 55 | 82 | 8.5 | 0.68 | 2 | AA | Present invention |
| 3 | 1 | Ultraviolet curable | Silicon oxide | 3 | HAP | 57 | StZn(1) | 1210 | 33 | 48 | 8.5 | 0.59 | 1 | AA | Present invention |
| 4 | 1 | Ultraviolet curable | Silicon oxide | 4 | HAP | 20 | StZn(1) | 1210 | 28 | 20 | 8.5 | 0.62 | 3 | AA | Present invention |
| 5 | 1 | Ultraviolet curable | Silicon oxide | 5 | HAP | 103 | StZn(2) | 5370 | 68 | 82 | 8.5 | 0.89 | 1 | AA | Present invention |
| 6 | 1 | Ultraviolet curable | Silicon oxide | 6 | HAP | 103 | StZn(3) | 369 | 36 | 82 | 8.5 | 1.10 | 2 | AA | Present invention |
| 7 | 1 | Ultraviolet curable | Silicon oxide | 7 | HAP | 103 | StZn(1) | 1210 | 36 | 82 | 6.5 | 0.75 | 7 | A | Present invention |
| 8 | 1 | Ultraviolet curable | Silicon oxide | 8 | AP | 146 | StZn(1) | 1210 | 38 | 82 | 8.5 | 0.66 | 9 | A | Present invention |
| 9 | 1 | Ultraviolet curable | Silicon oxide | 9 | SA(2) | 292 | StZn(1) | 1210 | 39 | 82 | 8.5 | 0.62 | 8 | A | Present invention |
| 10 | 1 | Ultraviolet curable | Silicon oxide | 10 | HAP | 103 | StAl | 1580 | 33 | 82 | 8.5 | 0.55 | 4 | AA | Present invention |
| 11 | 1 | Ultraviolet curable | Silicon oxide | 11 | HAP | 103 | CaF₂(1) | 210 | 19 | 82 | 8.5 | 0.61 | 10 | A | Present invention |
| 12 | 2 | Ultraviolet curable | Tin oxide | 1 | HAP | 103 | StZn(1) | 1210 | 41 | 82 | 8.5 | 0.62 | 1 | AA | Present invention |
| 13 | 3 | Ultraviolet curable | - | 1 | HAP | 103 | StZn(1) | 1210 | 41 | 82 | 8.5 | 0.98 | 5 | AA | Present invention |
| 14 | 4 | Electron beam curable | Silicon oxide | 1 | HAP | 103 | StZn(1) | 1210 | 41 | 82 | 8.5 | 0.52 | 0 | AA | Present invention |
| 15 | 1 | Ultraviolet curable | Silicon oxide | 12 | - | - | StZn(1) | 1210 | 71 | 82 | 8.5 | 1.08 | 33 | B | Comparative Example |
| 16 | 1 | Ultraviolet curable | Silicon oxide | 13 | HAP | 57 | StZn(1) | 1210 | 41 | 82 | 8.5 | 1.21 | 24 | B | Comparative Example |
| 17 | 1 | Ultraviolet curable | Silicon oxide | 14 | HAP | 198 | CaF₂(2) | 105 | 14 | 82 | 8.5 | 0.99 | 21 | B | Comparative Example |
| 18 | 5 | Thermoplastic | | 1 | HAP | 103 | StZn(1) | 1210 | 41 | 82 | 8.5 | 1.58 | 5 | A | Comparative Example |

The results of Examples demonstrate that the image forming system of the present invention enables both inhibition of wear and tear of the organic photoreceptor and lowering of deposits on the organic photoreceptor.

The above means of the present embodiments make it possible to provide the image forming system and an image forming method that enable both inhibition of wear and tear of the organic photoreceptor and lowering of deposits on the organic photoreceptor.

The exhibition mechanism or action mechanism of the effects by the present embodiments is not clear, however, is conjectured as follows.

The organic photoreceptor used in the image forming system of the present embodiments is characterized in that it has the protective layer containing a cured resin. This inhibits wear and tear of the photoreceptor. On the other hand, as described above, the wear and tear being inhibited makes it difficult for a photoreceptor surface to be refreshed, thus facilitating adhesion of foreign matters to the photoreceptor surface.

One possible reason why supplying lubricant onto the photoreceptor solely is unable to sufficiently lower deposits in image formation using an organic photoreceptor with a protective layer containing the cured resin, is considered to be due to non-lubricant particles that were released from toner base particles and adhered on the photoreceptor, being nucleus materials of foreign matters adhered thereto. These non-lubricant particles are those externally added to the toner base particles in order to improve chargeability, heat resistance, fluidity, and the like of toner. The non-lubricant particles have no function of lowering adhesiveness between the foreign matters and the photoreceptor as lubricant particles do, however, on the contrary, they can become nucleus materials of foreign matters adhered thereto.

In order to lower deposits on the photoreceptor while maintaining the amount of non-lubricant particles added for chargeability or the like, the non-lubricant particles are preferably unlikely to be released from the toner base particles. Non-lubricant particles that were not released from the toner base particles have a high possibility to be transferred to a recording medium together with the toner base particles or removed in a cleaning step, thereby making it difficult for them to become nucleus materials of foreign matters adhered thereto.

On the other hand, as described above, the lubricant particles have a function of lowering adhesiveness between the foreign matters and the photoreceptor, by being released from the toner base particles followed by supplied on the photoreceptor, thereby preferably facilitating release of the lubricant particles from the toner base particles.

In view of such circumstances, “toner in which lubricant particles are likely to be released from toner base particles and non-lubricant particles are unlikely to be released from the toner base particles” is realized in the present embodiments, and further, using such toner together with an organic photoreceptor having a protective layer containing a cured resin, enables both inhibition of wear and tear of the organic photoreceptor and lowering of deposits on the photoreceptor to be achieved.

The “toner in which lubricant particles are likely to be released from toner base particles and non-lubricant particles are unlikely to be released from the toner base particles” was achieved by using toner base particles having a plurality of convex portions on the surface of the toner base particles and by designing a toner composition further so as to satisfy the relationship of the following formula (1).

$$\text{D3} \leq \text{D1} \leq \text{D2} \qquad \text{Formula (1)}$$

D1: An average spacing of convex portions on a surface of toner base particles
D2: A median diameter of a lubricant particle with the smallest median diameter
D3: A median diameter of a non-lubricant particle with the largest median diameter

In the case of toner base particles with convex portions on their surface, external additive particles that are smaller than the spacing of convex portions (≈concave portion), penetrate into concave portions upon external addition and are firmly immobilized on a surface of toner base particles, making it difficult for them to be released. The external additive particles that are larger than the spacing of convex portions, on the other hand, cannot penetrate into the concave portions upon the external addition and adhere on the surface of convex portions, which lowers a contact area with the toner base particles and facilitates being released.

The relation of D1≤D2 in formula (1) indicates that median diameter D2 of a lubricant particle with the smallest median diameter is equal to or larger than average spacing D1 of convex portions on the surface of toner base particle. The “lubricant particle with the smallest median diameter” refers to a type of lubricant particle in a case in which only one type of lubricant particle is present, and refers to a type of lubricant particle with the smallest median diameter in the case of the presence of plural types of lubricant particles. When D1≤D2 is satisfied, most of the lubricant particles are composed of particles that are larger than the spacing of convex portions of toner base particles, resulting in that “lubricant particles become toner likely to be released from toner base particles.”

The relation of D3≤D1 in formula (1) indicates that median diameter D3 of a non-lubricant particle with the largest median diameter is equal to or less than average spacing D1 of convex portions on the surface of toner base particles. The “non-lubricant particle with the largest median diameter” refers to a type of non-lubricant particle in a case in which only one type of non-lubricant particle is present, and refers to a type of non-lubricant particle with the largest median diameter in the case of the presence of plural types of non-lubricant particles. When D3≤D1 is satisfied, most of the non-lubricant particles are composed of particles that are smaller than the spacing of convex portions of toner base particles, resulting in that “non-lubricant particles become toner unlikely to be released from toner base particles.”

Therefore, designing a toner composition so as to satisfy the relationship of formula (1) enables “toner in which lubricant particles are likely to be released from toner base particles and non-lubricant particles are unlikely to be released from toner base particles” to be realized.

Such a mechanism is conjectured to enable the image forming system of the present embodiments to achieve both inhibition of wear and tear of the organic photoreceptor and lowering of deposits on the organic photoreceptor.

Although embodiments of the present invention have been described and illustrated in detail, the disclosed embodiments are made for purposes of illustration and example only and not limitation. The scope of the present invention should be interpreted by terms of the appended claims.

1. An image forming system using: an organic photoreceptor; and a toner for electrostatic charge image development comprising toner particles,
wherein the organic photoreceptor has a protective layer comprising a cured resin;
the toner particle has a form in which at least one type of lubricant particle and at least one type of non-lubricant particle are contained or adhered on a surface of a plurality of convex portions or on a surface between the plurality of convex portions, of a toner base particle having the plurality of convex portions on a surface thereof; and
an average spacing D1 of the convex portions on the surface of the toner base particle, a median diameter D2 of the lubricant particle having the smallest median diameter, and a median diameter D3 of the non-lubricant particle having the largest median diameter, satisfy the relationship of the following formula (1):
$$\text{D3} \text{} \leq \text{} \text{D1} \text{} \leq \text{} \text{D2} \text{.} \qquad \text{Formula (1)}$$
.

2. The image forming system according to claim 1, wherein the convex portion comprises a hybrid amorphous polyester resin in which a vinyl-based polymerization segment and an amorphous polyester-based polymerization segment are bonded via a bireactive monomer.

3. The image forming system according to claim 1, wherein the lubricant particle is a fatty acid metal salt particle.

4. The image forming system according to claim 1, wherein at least one type of the non-lubricant particles is a particle with a Mohs hardness of 8 or more.

5. The image forming system according to claim 1, wherein the protective layer comprises metal oxide particles.

6. The image forming system according to claim 1, comprising a charger of a roller charging type.

7. The image forming system according to claim 3, wherein a release ratio R of the fatty acid metal salt particles from the toner base particles in the toner particles, as determined by an ultrasonic treatment method under the following conditions, is within a range of 20 to 60%,
[Conditions of ultrasonic treatment method]
Procedure 1: a NET intensity W1 of a metal element derived from fatty acid metal salt particles in toner particles is measured by X-ray fluorescence analysis;
Procedure 2: an aqueous dispersion of the toner particles is prepared;
Procedure 3: the aqueous dispersion prepared is subjected to ultrasonic treatment;
Procedure 4: the fatty acid metal salt particles released from toner base particles by ultrasonic treatment are removed;
Procedure 5: a NET intensity W2 of a metal element derived from the fatty acid metal salt particles in the toner particles from which the released fatty acid metal salt particles have been removed, is measured by X-ray fluorescence analysis; and
Procedure 6: release ratio R [%] is determined from the following formula (2):
$$\text{R} \text{=} \left(\text{W1} \text{-} \text{W2}\right) / \text{W1} \times \text{100} \text{.} \qquad \text{Formula (2)}$$
.

8. A method for forming an image using an organic photoreceptor and a toner for electrostatic charge image development comprising toner particles,
wherein the organic photoreceptor has a protective layer comprising a cured resin;
the toner particle has a form in which at least one type of lubricant particle and at least one type of non-lubricant particle are contained or adhered on a surface of a plurality of convex portions or on a surface between the plurality of convex portions, of a toner base particle having the plurality of convex portions on a surface thereof; and
an average spacing D1 of the convex portions on the surface of the toner base particle, a median diameter D2 of the lubricant particle having the smallest median diameter, and a median diameter D3 of the non-lubricant particle having the largest median diameter, satisfy the relationship of the following formula (1):
$$\text{D3} \text{} \leq \text{} \text{D1} \text{} \leq \text{} \text{D2} \text{.} \qquad \text{Formula (1)}$$
.
